(19) United States
(12) Patent Application Publication
(10) Pub. No.: US 2009/0231634 A1
(43) Pub. Date: Sep. 17, 2009

(54) IMAGE DRAWING APPARATUS AND METHOD

(75) Inventor: Katsuto Sumi, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku, Tokyo (JP)

(21) Appl. No.: 11/910,212

(22) PCT Filed: Mar. 31, 2006
(86) PCT No.: PCT/JP2006/307398

§ 371 Date: Sep. 28, 2007

(30) Foreign Application Priority Data
Mar. 31, 2005 (JP) 2005-103783
Jun. 16, 2005 (JP) 2005-176348

(51) Int. Cl. H04N 1/04

(52) U.S. Cl. 358/474

(57) ABSTRACT

In an image drawing apparatus which performs N-tuple image drawing, an image drawing head is mounted so that the pixel column direction of two-dimensionally arranged usable pixels and a scan direction of the image drawing head with respect to an image drawing surface form a predetermined set inclination angle. A pixel-to-utilize setting unit sets, based on variance in the inclination angles of pixel columns with respect to the scan direction, pixels-to-utilize, which are utilized in N-tuple image drawing, to operate among a great number of usable pixels. The pixel-to-utilize setting unit includes a pixel-to-utilize designation unit, a setting changing unit or the like. An image is drawn on the image drawing surface by causing the pixels-to-utilize, designated by setting, to operate while the image drawing head is relatively moved with respect to a stage.

### TECHNICAL FIELD

The present invention relates to an image drawing apparatus and an image drawing method. Particularly, the present invention relates to an image drawing apparatus and an image drawing method for forming a two-dimensional pattern represented by image data on an image drawing surface by performing multiple image drawing.

### BACKGROUND ART

Conventionally, various kinds of image drawing apparatus are well known as an image drawing apparatus which forms a desired two-dimensional pattern, represented by image data, on an image drawing surface by an image drawing head. A typical example of such an image drawing apparatus is an exposure apparatus for forming a desired two-dimensional pattern on an exposure surface, such as a photosensitive material, by an exposure head. The exposure apparatus is used in production of semiconductor substrates or printing plates. Generally, the exposure head of the exposure apparatus includes a pixel array, such as a light source array and a spatial light modulation element. The pixel array includes a great number of pixels and generates a group of light spots which forms a desired two-dimensional pattern. In the exposure apparatus, the desired two-dimensional pattern can be formed on the exposure surface by causing the exposure head to operate while relatively moving the exposure head with respect to the exposure surface.

Recently, some kinds of exposure apparatus which substantially expose each spot on an exposure surface to light a plurality of times have been proposed. The exposure head of the exposure apparatus includes a pixel array, in which pixels are two-dimensionally arranged, to improve resolution or the like. In the exposure apparatus, the exposure head is used so that a scan line of a light beam emitted from each of the pixels matches a scan line of a light beam emitted from another pixel in the pixel array.

For example, in Japanese Unexamined Patent Publication No. 2004-181723, an exposure apparatus which can produce even images at high resolution is proposed. In the exposure apparatus, image drawing is controlled while the actual inclination angle of a spatial light modulation element (micromirror) in a digital micromirror device (DMD) is taken into consideration. Generally, the DMD is a mirror device which has an exposure head, and in which a great number of micromirrors is two-dimensionally arranged. The micromirrors are arranged to form a matrix of L rows×M columns and the angle of a reflection surface of each of the micromirrors changes based on a control signal. In actual exposure, an exposure surface is scanned with the exposure head in a constant direction along the exposure surface. In the apparatus disclosed in Japanese Unexamined Patent Publication No. 2004-181723, the number of image drawing pixels which are utilized in exposure is controlled for each of image drawing columns. The number of image drawing pixels is controlled based on an error of the inclination angle of the two-dimensionally arranged micromirrors with respect to the scan direction from the set angle thereof. Accordingly, it is possible to control a deviation of a pitch of scanning paths of exposure beams, reflected by the micromirrors, at a constant value. Consequently, even images can be produced.

However, in the apparatus disclosed in Japanese Unexamined Patent Publication No. 2004-181723, it is assumed that an error of the inclination angle of each of the micromirrors is the same in all of the two-dimensionally arranged micromirrors. Therefore, it is assumed that a pitch of the scanning paths of the exposure beams is shifted by a constant amount in the entire image drawing surface. Hence, if a figure distortion is present in an image, it is impossible to sufficiently suppress unevenness of the image. The figure distortion is a distortion, in which a deviation of an image drawing spot column pitch is not the same among image drawing spot columns. Here, the phrase “image drawing spot column” means a column of image drawing spots. The phrase “image drawing spot column pitch” means a pitch between columns of image drawing spots. When a figure distortion is present, there is a problem that it is impossible to sufficiently suppress unevenness and to draw a high quality image.

To solve the problems, as described above, accuracy in adjustment of the mounting angle of the exposure head, accuracy in arrangement of pixels and accuracy in adjustment of an optical system should be improved. However, if these kinds of accuracy are tried to be improved, it is inevitable that the production cost of the apparatus will become extremely high.

The problem, as described above, occurs not only in the exposure apparatus but also in other kinds of image drawing apparatus, such as an inkjet printer, for example. The inkjet printer is a printer including an inkjet recording head which performs image drawing by ejecting ink droplets onto an image drawing surface.

### DISCLOSURE OF THE INVENTION

In view of the foregoing circumstances, it is an object of the present invention to provide an image drawing apparatus and an image drawing method in which unevenness in resolution or density is reduced. Unevenness in resolution or density is caused by an error in the mounting angle of an image drawing head or a pattern distortion in a drawn image. Particularly, it is an object of the present invention to provide an image drawing apparatus and an image drawing method which can reduce unevenness in a drawn image even if the value of the inclination angle of each of image drawing spot columns with respect to the scan direction is not the same, in other words, when there is variance in the values of inclination angles.

Specifically, an image drawing apparatus according to the present invention is an image drawing apparatus for forming a two-dimensional pattern represented by image data on an image drawing surface by performing N-tuple image drawing (N is a natural number greater than or equal to 1), the apparatus comprising:

at least one image drawing head, each including a pixel array;

a movement means for relatively moving each of the at least one image drawing head in a scan direction with respect to the image drawing surface; and

a pixel-to-utilize setting means for setting pixels-to-utilize, based on variance in the inclination angles of pixel columns in the pixel array with respect to the scan direction, for each of the at least one image drawing head, wherein each of the at least one image drawing head is mounted with respect to the image drawing surface so that the pixel column direction of usable pixels and a relative scan direction of each of the at least one image drawing head form a predetermined set inclination angle, and wherein the pixel array includes a great number of two-dimensionally arranged usable pixels and generates a group of image drawing spots which forms the two-dimensional pattern based on the image data, and wherein the pixel-to-utilize setting means sets the pixels-to-utilize so that the pixels-to-utilize, which are utilized in the N-tuple image drawing, operate among the great number of usable pixels. The term “pixels-to-utilize” means pixels which are utilized.

The pixel-to-utilize setting means may set the pixels-to-utilize based on an actual inclination angle formed by an actual pixel column direction on the image drawing surface, represented by the group of image drawing spots, and the scan direction.

The pixel-to-utilize setting means may include a pixel-to-utilize designation means for designating the pixels-to-utilize and a setting changing means for changing the setting so that only the pixels-to-utilize operate.

In the present invention, pixels are two-dimensionally arranged in a pixel array. In other words, the pixels are arranged in two directions. In the present invention, the phrase “pixel column” refers to the arrangement of pixels in a direction which forms a smaller angle with respect to the scan direction. The phrase “pixel row” refers to the arrangement of pixels in the other direction, which forms a larger angle with respect to the scan direction. Here, it is not always necessary that the pixels are arranged in the pixel array so as to form a rectangular grid. The pixels may be arranged so as to form a parallelogram, for example.

Further, in the present invention, the phrase “N-tuple image drawing” refers to image drawing based on a setting in which a straight line parallel to the scan direction intersects N pixel columns of pixels-to-utilize, which have been projected onto the image drawing surface, in an approximately entire region of an image drawing area on the image drawing surface. Here, the phrase “approximately entire region” is used because the number of pixel columns of the pixels-to-utilize, which intersect the straight line parallel to the scan direction, may decrease at an edge on either side of each pixel array. The number of the pixel columns may decrease because the pixel columns are inclined. In this case, even if a plurality of image drawing heads is used so that they are connected to each other, the number of the pixel columns of the pixels-to-utilize, which intersect the straight line parallel to the scan direction, may slightly increase or decrease because of an error in the mounting angle of each of the at least one image drawing head, an error in arrangement or the like. The phrase “approximately entire region” is also used because in a very small part of the image drawing area, which is less than or equal to resolution, a pixel pitch in a direction perpendicular to the scan direction may not be exactly the same as a pixel pitch in the other part of the image drawing area. The very small portion of the image drawing area is an area in a connecting region between pixel columns of the pixels-to-utilize. The pixel pitch in the very small part may not be exactly the same because of an error in the mounting angle, arrangement of pixels or the like. Since the pixel pitch may not be exactly the same, the number of pixel columns of pixels-to-utilize, which intersect the straight line parallel to the scan direction, may increase or decrease within the range of ±1.

Meanwhile, the phrase “ideal N-tuple image drawing” refers to image drawing based on a setting in which a straight line parallel to the scan direction intersects exact N number of pixel columns of pixels-to-utilize, which have been projected onto the image drawing surface, in the entire region of the image drawing area on the image drawing surface.

In the following description, a phrase “N-tuple exposure” will be used as a phrase corresponding to the phrase “N-tuple image drawing” in an embodiment of the present invention, in which the image drawing apparatus or the image drawing method according to the present invention is applied to an exposure apparatus or an exposure method.

Further, the “pixel-to-utilize designation means” in the present invention may be a means for receiving manual designation of a pixel-to-utilize or pixels-to-utilize. Alternatively, the “pixel-to-utilize designation means” may be a means which includes a position detection means, a selection means or the like, which will be described later, and which automatically selects an optimal pixel-to-utilize. Further, the expression “variance in the inclination angles of pixel columns in the pixel array with respect to the scan direction” refers to a state in which an error in the inclination of each of the pixel columns in the two-dimensional pixel array is not the same among all of the pixel columns. The expression refers to a state in which an error in the inclination is different in each column. The expression also refers to a state in which an error in the inclination angle of each group of a plurality of columns is different from an error in that of another group. When there is variance in the inclination angles of the pixel columns, a figure distortion is generated in a drawn image. In the present invention, the “pixel-to-utilize designation means” is a means for automatically selecting a pixel (namely, “pixel-to-utilize”), which is utilized in image drawing, in the two-dimensional pixel array. Alternatively, the “pixel-to-utilize designation means” is a means for receiving designation of a pixel-to-utilize, which has been manually selected. The “pixel-to-utilize designation means” automatically selects the pixel-to-utilize or pixels-to-utilize or receives designation thereof so as to suppress unevenness of the drawn image caused by a figure distortion.

Further, in the above description, the expression “change the setting so that only the pixels-to-utilize operate” may refer to changing the setting of the pixels other than the pixels-to-utilize to OFF so that among the usable pixels, the pixels other than the pixels-to-utilize do not operate, for example. Alternatively, the expression may refer to changing the state of a part of the image data, which is sent to the pixels other than the pixels-to-utilize, to an off state (in other words, data representing “suppress image drawing”). Alternatively, the expression may refer to changing the setting so that the pixels other than the pixels-to-utilize also operate among the usable pixels, however an image drawing medium, such as a light beam or ink droplets, from the pixels other than the pixels-to-utilize is blocked so as not to reach the image drawing surface.

Further, in the image drawing apparatus according to the present invention, it is preferable that the set inclination angle θ satisfies the following arithmetic expression:

s·p·sin θ≧Nδ,

where s is the number of pixels constituting each of pixel columns of the usable pixels, p is a pixel pitch of the usable pixels in the pixel column direction, and δ is a pixel column pitch of the usable pixels along a direction perpendicular to the scan direction. The phrase “pixel column pitch” means a pitch between columns of pixels.

Further, the pixel-to-utilize designation means may specify an actual inclination angle formed by the actual direction of each of the image drawing spot columns on the image drawing surface, represented by the group of image drawing spots, and the scan direction for each of the image drawing spot columns and designate the pixels-to-utilize so as to absorb an error between the actual inclination angle and the set inclination angle for each of the image drawing spot columns.

Further, the pixel-to-utilize designation means may determine an image drawing spot column on the image drawing surface, which corresponds to each of a plurality of pixel columns selected from pixel columns of the usable pixels, as a representative image drawing spot column, specify an actual inclination angle formed by the direction of each of the representative image drawing spot columns and the scan direction for each of the representative image drawing spot columns and designate the pixels-to-utilize so that each error between the relevant actual inclination angle and the set inclination angle is absorbed.

Further, each of the actual inclination angles may be one of an average value, a median value, a maximum value and a minimum value of individual actual inclination angles specified by each of the direction of the representative image drawing spot column and that of an image drawing spot column in the vicinity thereof and the scan direction.

Further, the pixel array in each of the at least one image drawing head may generate a group of light spots as the group of image drawing spots.

In the image drawing apparatus, the pixel array in each of the at least one image drawing head may generate a group of light spots as the group of image drawing spots, and the pixel-to-utilize designation means may include a position detection means for detecting the positions of light spots constituting the group of light spots on the image drawing surface for each of the at least one image drawing head and a selection means. The selection means may select, based on a detection result by the position detection means, a plurality of representative regions, each including at least one image drawing portion formed by a connecting portion between pixel columns of the pixels-to-utilize on the image drawing surface, for each of the at least one image drawing head, specify a pixel-not-to-utilize among the usable pixels so that ideal N-tuple image drawing is performed in each of the representative regions, and select pixels other than the pixel-not-to-utilize as the pixels-to-utilize. The term “pixel-not-to-utilize” means a pixel which is not utilized.

In the image drawing apparatus, the position detection means may detect the positions of at least two light spots in each of a plurality of pixel columns. In the image drawing apparatus, the selection means may specify, based on the result of detection, an actual inclination angle formed by the scan direction and the actual direction of each of the pixel columns represented by the light spots, and which have been projected onto the image drawing surface, and specify the pixel-not-to-utilize based on the actual inclination angle.

The selection means may use a column of the light spots on the image drawing surface, which corresponds to each of a plurality of pixel columns of usable pixels in the pixel array, as a representative light spot column and specify the actual inclination angle of each of the plurality of representative light spot columns based on the result of detection of the positions of at least two light spots among the light spots constituting the representative light spot column and a light spot column in the vicinity thereof by the position detection means. The phrase “light spot column” means a column of light spots and the phrase “representative light spot column” means a representative column of light spots.

The selection means may use a plurality of columns of the light spots on the image drawing surface, which corresponds to a plurality of pixel columns of the usable pixels, as representative light spot columns, specify an individual actual inclination angle formed by the scan direction and the direction of each of the representative light spot columns and a light spot column in the vicinity thereof and regard a representative value of the individual actual inclination angles as the actual inclination angle of each of the representative light spot columns.

The representative value of the individual actual inclination angles may be one of an average value, a median value, a maximum value, and a minimum value of the individual actual inclination angles of a representative light spot columns and a light spot column in the vicinity thereof.

The image drawing apparatus according to the present invention may be an image drawing apparatus further comprising:

a reference image drawing means for performing reference image drawing by using only pixels which constitute pixel columns having (N−1) column intervals therebetween from among the great number of usable pixels for each of the at least one image drawing head in order to designate the pixels-to-utilize by the pixel-to-utilize designation means when N is greater than or equal to 2.

Alternatively, the image drawing apparatus according to the present invention may be an image drawing apparatus further comprising:

a reference image drawing means for performing reference image drawing by using only pixels, of which the number corresponds to 1/N of the total number of the usable pixels, and which constitute a group of pixel rows which are adjacent to each other, among the great number of usable pixels for each of the at least one image drawing head in order to designate the pixels-to-utilize by the pixel-to-utilize designation means when N is greater than or equal to 2. Here, if the total number of the usable pixels is not divisible by N, a group including pixels, of which the number is closest to 1/N of the total number of pixels or the like, may be selected as the “pixels, of which the number corresponds to 1/N of the total number of the usable pixels, and which constitute a group of pixel rows which are adjacent to each other”. The number closest to 1/N of the total number of pixels may be the maximum number of pixels below 1/N of the total number of pixels or the minimum number of pixels above 1/N of the total number of pixels.

Further, the image drawing apparatus according to the present invention may be an image drawing apparatus further comprising:

a data conversion means for converting the image data so that the size of a predetermined portion of the two-dimensional pattern represented by the image data becomes the same as that of a corresponding portion which can be drawn by use of the designated pixels-to-utilize.

Further, in the image drawing apparatus according to the present invention, the pixel array may be a spatial light modulation element for modulating light emitted from a light source, based on the image data, for each pixel. Here, the “light source” may be a light source incorporated into each of the at least one image drawing head (exposure head). Alternatively, the “light source” may be a light source which is provided outside each of the at least one image drawing head for each of the at least one image drawing head. The “light source” may be shared by a plurality of image drawing heads.

N may be a natural number within the range from 3 to 7.

An image drawing method according to the present invention is an image drawing method using at least one image drawing head which includes a pixel array, wherein each of the at least one image drawing head is mounted with respect to the image drawing surface so that the pixel column direction of usable pixels and a relative scan direction of each of the at least one image drawing head form a predetermined set inclination angle, and wherein the pixel array includes a great number of two-dimensionally arranged usable pixels and generates a group of image drawing spots which forms a two-dimensional pattern based on the image data,

the method comprising the steps of:

setting pixels-to-utilize, based on variance in the inclination angles of pixel columns in the pixel array with respect to the scan direction, so that the pixels-to-utilize, which are utilized in N-tuple image drawing (N is a natural number greater than or equal to 1), operate among the great number of usable pixels for each of the at least one image drawing head; and

forming the two-dimensional pattern on the image drawing surface by causing each of the at least one image drawing head to operate while relatively moving each of the at least one image drawing head in the scan direction with respect to the image drawing surface.

The pixels-to-utilize may be set based on an actual inclination angle formed by an actual pixel column direction on the image drawing surface, represented by the group of image drawing spots, and the scan direction.

The step of setting the pixels-to-utilize may include a step of designating the pixels-to-utilize and a step of changing the setting so that only the pixels-to-utilize operate.

Here, the expression “causing each of the at least one image drawing head to operate while relatively moving each of the at least one image drawing head in the scan direction with respect to the image drawing surface” may refer to performing continuous image drawing while constantly moving the each of the at least one image drawing head. Alternatively, the expression may refer to performing image drawing while moving each of the at least one image drawing head stepwise. When the image drawing head is moved stepwise, the image drawing head is stopped at each moved position to perform image drawing.

In the image drawing apparatus and the image drawing method according to the present invention, a distortion in a drawn image, which is caused by inclination locality of the image drawing element array, can be more efficiently corrected. Consequently, it is possible to more effectively correct unevenness and to draw a higher quality image. Further, the image drawing apparatus and the image drawing method can cope with a large figure distortion of a two-dimensional image drawing element array without improving the accuracy in adjustment of the optical system or the like. Therefore, it is possible to draw an image which has a high image quality without increasing a production cost.

If the pixel-to-utilize designation means includes a position detection means and a selection means, pixels-to-utilize can be designated without an operation by a skilled worker, such as visually checking the reference image drawing result or the like. Therefore, the pixels-to-utilize, of which the number is the number of pixels which can minimize an influence of an error in the mounting angle of an image drawing head or a relative pattern distortion, can be automatically designated. Further, setting of the image drawing apparatus can be automatically performed.

Further, when N is 2 or greater, reference image drawing can be performed by using only pixels which constitute pixel columns having (N−1) column intervals therebetween or by using only pixels which correspond to 1/N of the total number of usable pixels, and which constitute a group of pixel rows which are adjacent to each other. When reference image drawing can be performed in this manner, a pattern which is formed by approximately single image drawing, and which is simpler than a pattern formed by multiple image drawing, can be obtained. Therefore, when an operator visually checks the pattern or the like to designate pixels-to-utilize, he/she can more easily designate appropriate pixels-to-utilize. Hence, it becomes possible to more easily set optimal pixels-to-utilize.

Further, if the image data is converted so that the size of a predetermined portion of the two-dimensional pattern represented by the image data becomes the same as that of a corresponding portion, it is possible to match the size of the two-dimensional pattern represented by the image data to that of a predetermined portion which can be drawn by use of the designated pixels-to-utilize. Therefore, it is possible to form a highly accurate pattern which is exactly the same as a desired two-dimensional pattern on the image drawing surface.

### BRIEF DESCRIPTION OF THE IMAGE DRAWINGS

FIG. 1 is a perspective view illustrating the external view of an exposure apparatus, which is an embodiment of an image drawing apparatus according to the present invention;

FIG. 2 is a perspective view illustrating the structure of a scanner in the exposure apparatus illustrated in FIG. 1;

FIG. 3A is a plan view illustrating an exposed region, which is formed on an exposure surface of a photosensitive material;

FIG. 3B is a plan view illustrating the arrangement of exposure areas formed by exposure heads;

FIG. 4 is a schematic perspective view illustrating the structure of an exposure head of the exposure apparatus illustrated in FIG. 1;

FIG. 5A is a plan view illustrating the detailed structure of the exposure head in the exposure apparatus illustrated in FIG. 1;

FIG. 5B is a side view illustrating the detailed structure of the exposure head in the exposure apparatus illustrated in FIG. 1;

FIG. 6 is a partial enlarged view illustrating the structure of a DMD in the exposure apparatus illustrated in FIG. 1;

FIG. 7A is a perspective view for explaining the operation of the DMD;

FIG. 7B is a perspective view for explaining the operation of the DMD;

FIG. 8 is a perspective view illustrating the structure of a fiber array light source;

FIG. 9 is a frontal view illustrating the arrangement of light emission spots in a laser emission portion of the fiber-array light source;

FIG. 10A is a diagram for explaining an error in an inclination angle of a pixel column in a pixel array with respect to a scan direction and unevenness in a drawn image when the error in the inclination angle is not present;

FIG. 10B is a diagram for explaining an error in an inclination angle of a pixel column in a pixel array with respect to a scan direction and unevenness in a drawn image when the inclination angle is less than a set inclination angle;

FIG. 10C is a diagram for explaining an error in an inclination angle of a pixel column in a pixel array with respect to a scan direction and unevenness in a drawn image when the inclination angle is greater than the set inclination angle;

FIG. 11 is a diagram for explaining unevenness which is generated in a drawn image when there is variance in the inclination angles of pixel columns in the pixel array with respect to the scan direction;

FIG. 12 is a diagram for explaining how swath unevenness appears in detail;

FIG. 13 is a diagram illustrating the positional relationship between an exposure area by a DMD and a slit corresponding to the exposure area;

FIG. 14 is a diagram for explaining measurement of the position of a light spot on an exposure surface by use of a slit;

FIG. 15 is a diagram for explaining a state in which the unevenness generated in a pattern on the exposure surface has been improved by causing only the selected pixels-to-utilize to operate;

FIG. 16 is a diagram for explaining an example of unevenness which appears in a representative region in a drawn image when double exposure is performed;

FIG. 17 is a diagram for explaining unevenness generated in a pattern on the exposure surface when only selected pixels-to-utilize are caused to operate for the representative region, illustrated in FIG. 16;

FIG. 18 is a diagram for explaining a state in which unevenness generated in a pattern on the exposure surface has been improved by causing only selected pixels-to-utilize to operate in multiple exposure;

FIG. 19A is a diagram for explaining an example of a pattern distortion when the pattern distortion is a magnification ratio distortion;

FIG. 19B is a diagram for explaining an example of a pattern distortion when the pattern distortion is a beam diameter distortion;

FIG. 20A is a diagram for explaining an example of reference exposure;

FIG. 20B is a diagram for explaining an example of reference exposure;

FIG. 21A is a diagram for explaining an example of reference exposure;

FIG. 21B is a diagram for explaining an example of reference exposure;

FIG. 22A is a diagram illustrating a straight line formed by pixel image drawing spots drawn on the exposure surface when a deviation amount at a connecting portion is obtained;

FIG. 22B is a diagram illustrating a straight line formed by pixel image drawing spots drawn on the exposure surface when a deviation amount at a connecting portion is obtained;

FIG. 22C is a diagram illustrating a straight line formed by pixel image drawing spots drawn on the exposure surface when a deviation amount at a connecting portion is obtained;

FIG. 23 is a diagram illustrating a correspondence between the state of a micromirror and a straight line portion formed by the pixel image drawing spots when the deviation amount at the connecting portion is obtained;

FIG. 24 is a diagram illustrating a straight line portion which extends in an X-axis direction when a deviation amount at the connecting portion is obtained; and

FIG. 25 is a diagram illustrating a reference scale.

### BEST MODE FOR CARRYING OUT THE INVENTION

An exposure apparatus, which is an embodiment of an image drawing apparatus according to the present invention, will be described in detail with reference to the attached drawings.

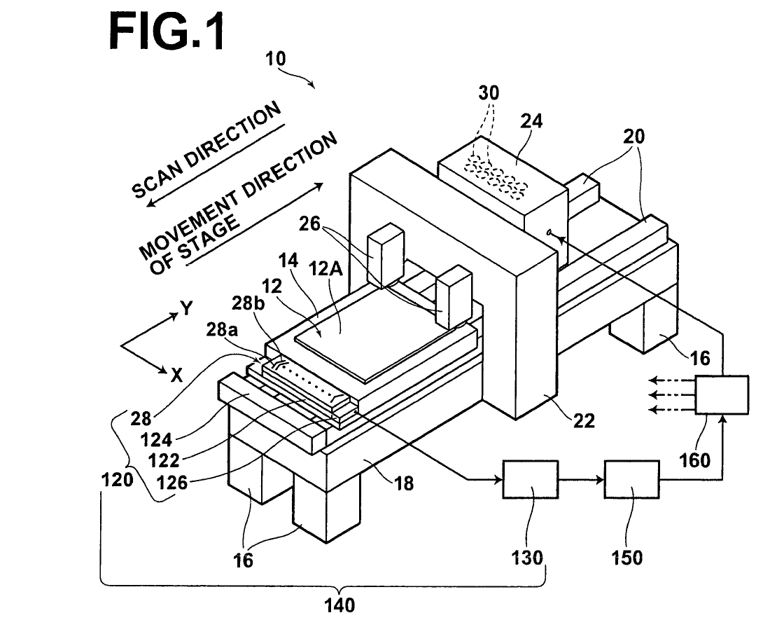

As illustrated in FIG. 1, an exposure apparatus 10 in the present embodiment includes a moving stage 14 which has a shape of a flat plate. The moving stage 14 holds a sheet-type photosensitive material 12 on a surface thereof by suction. Two guides 20 which extend along the movement direction of the stage 14 are provided on the upper surface of a mount 18 which has a shape of a thick plate. The mount 18 is supported by four legs 16. The stage 14 is placed so that the longitudinal direction thereof is positioned in the movement direction of the stage 14 and supported by the guides 20. The guides 20 support the stage 14 so as to allow back and forth movement of the stage 14. Further, the exposure apparatus 10 includes a stage driving apparatus 124 for driving the stage 14, which is a movement means, along the guides 20.

A U-shaped gate 22 is provided at the center of the mount 18 so as to straddle the movement path of the stage 14. Each end of the U-shaped gate 22 is fixed onto either side of the mount 18. A scanner 24 is provided on one side of the gate 22 and a plurality (for example, two) of sensors 26 is provided on the opposite side of the gate 22. The plurality of sensors 26 detects a leading edge and a rear edge of the photosensitive material 12. Each of the scanner 24 and the sensors 26 is attached to the gate 22 and placed at a fixed position above the movement path of the stage 14. The scanner 24, the sensors 26, a stage driving apparatus 124 and the like are connected to a controller 160 for controlling the operation of each unit and timing. Here, for the purpose of explanation, an X axis and a Y axis that are orthogonal to each other are defined on a flat plane parallel to the surface of the stage 14, as illustrated in FIG. 1.

At an edge of the stage 14 on the upstream side along the scan direction (hereinafter, simply referred to as “upstream side”), ten “L-shaped” slits 28 are formed at regular intervals. The L-shape of each of the slits 28 is a shape which opens toward the direction of the X axis. Each of the slits 28 includes a slit 28a on the upstream side and a slit 28b on the downstream side. The slits 28a and 28b are perpendicular to each other. The slit 28a forms an angle of −45 degrees with respect to the X axis and the slit 28b forms an angle of +45 degrees with respect to the X axis. A photo-detector 122 of a single cell type is provided below each of the slits 28. The photo-detector 122 is incorporated into the stage 14. Each of the photo-detectors is connected to a position specifying unit 126, which will be described later. The position specifying unit 126 is connected to an operation apparatus 130, which is a selection means for selecting a pixel-to-utilize.

The slit 28, photo-detector 122 and position specifying unit 126 form a position detection unit 120, which is a position detection means. Further, a pixel-to-utilize designation unit 140, which is a pixel-to-utilize designation means, includes the position detection unit 120 and the operation apparatus 130.

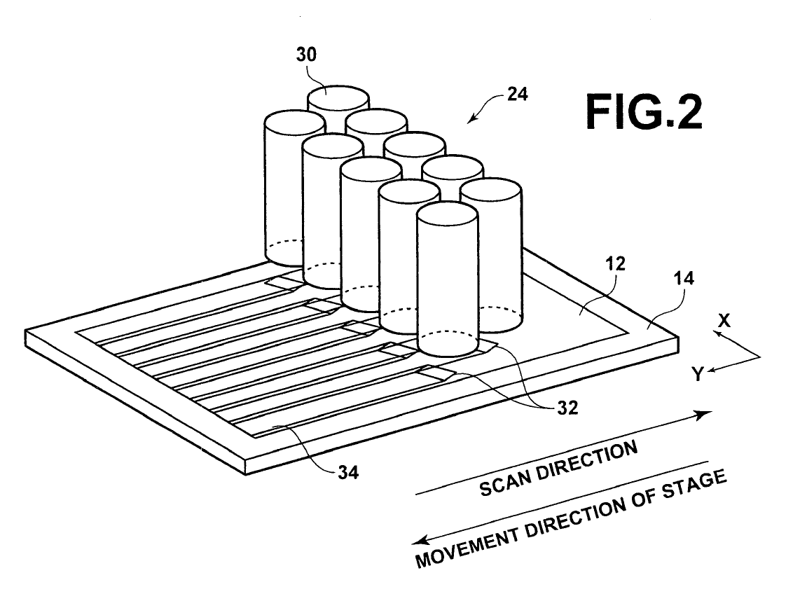

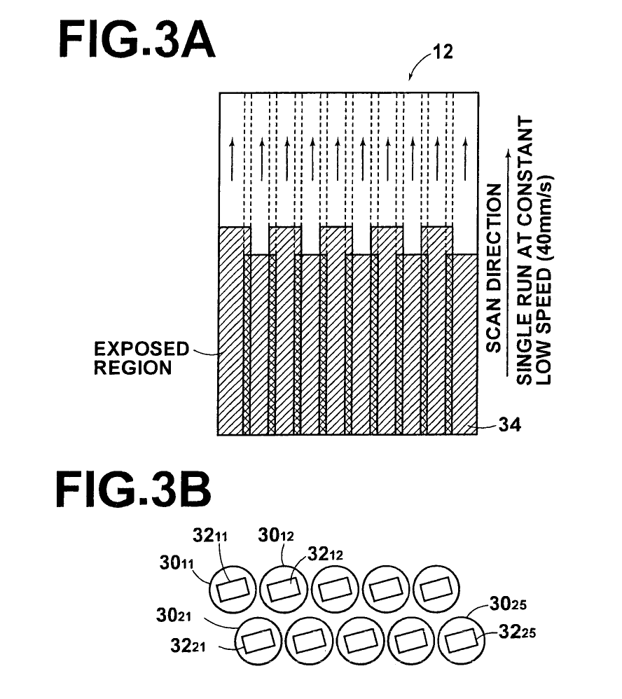

The scanner 24 includes ten exposure heads 30 which are arranged so as to substantially form a matrix of 2 rows×5 columns, as illustrated in FIG. 2 and FIG. 3B. Hereinafter, an exposure head 30 which is arranged in an m-th row, n-th column will be represented by an exposure head 30ₘₙ.

Each of the exposure heads 30 is mounted in the scanner 24 in such a manner that the pixel column direction of a digital micromirror device (DMD) 36 in each of the exposure heads 30 forms a predetermined set inclination angle θ with respect to the scan direction (the DMD will be described later). Therefore, an exposure area 32 formed by each of the exposure heads 30 is a rectangular area which inclines toward the scan direction. A band-shaped exposed region 34 is formed on the photosensitive material 12 by each of the exposure heads 30 as the stage 14 moves. Hereinafter, an exposure area 32 which is formed by an exposure head arranged in the m-th row, n-th column will be represented by an exposure area 32ₘₙ.

As illustrated in FIG. 3B, the exposure heads 30 are linearly arranged in rows. The exposure heads 30 in each of the rows are shifted from those in the other row in the arrangement direction thereof by a predetermined distance (a value obtained by multiplying the longer side of the exposure area by a natural number, which is 2 in this embodiment). The exposure heads 30 are shifted so that each of the band-shaped exposure areas 34 partially overlaps with an adjacent band-shaped exposure area or areas 34, as illustrated in FIG. 3A. Therefore, an area between an exposure area 32₁₁ and an exposure area 32₁₂ in the first row, that cannot be exposed to light, can be exposed to light by an exposure area 32₂₁ in the second row.

Here, the center position of each of the exposure heads 30 substantially matches the position of one of the ten slits 28. The size of each of the slits 28 is sufficiently large to cover the width of an exposure area 32 formed by an exposure head 30 corresponding to each of the slits 28.

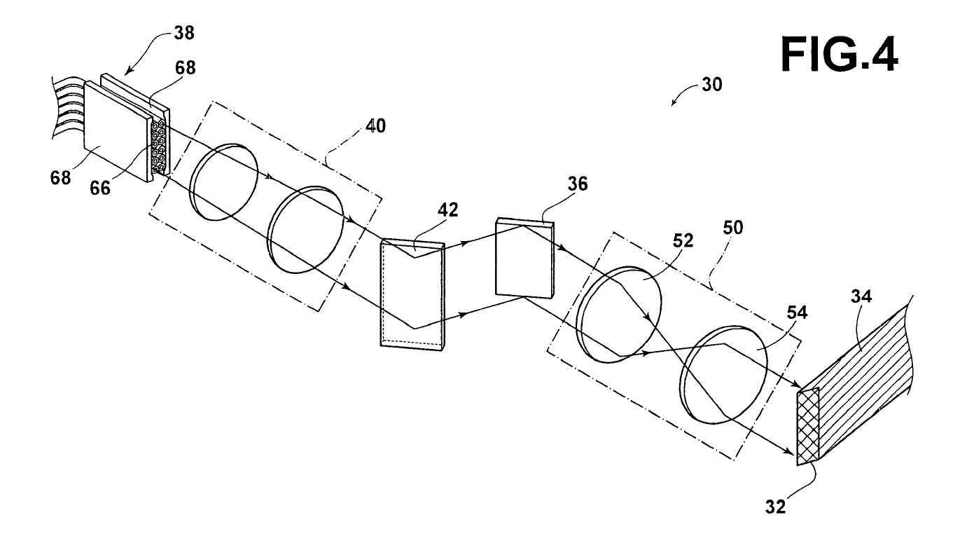

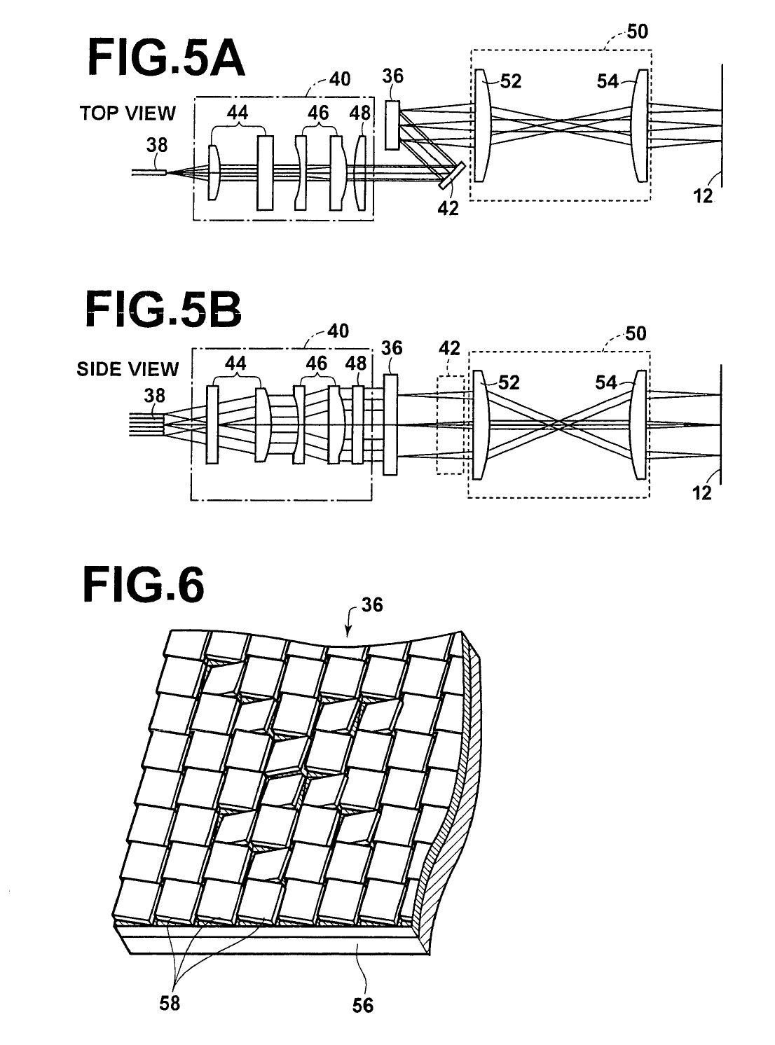

As illustrated in FIGS. 4, 5A and 5B, each of the exposure heads 30 includes a DMD 36 manufactured by Texas Instruments Incorporated in the U.S. The DMD 36 is a spatial light modulation element which modulates incident light, based on image data, for each pixel portion. The DMD 36 is connected to a controller 160 which includes a data processing unit and a mirror drive control unit. The data processing unit of the controller 160 generates, based on input image data, a control signal for controlling drive of each of micromirrors in a region-to-utilize of the DMD 36 for each of the exposure heads 30. Further, the mirror drive control unit controls, based on the control signal generated by the image data processing unit, the angle of a reflection surface of each of the micromirrors in the DMD 36 for each of the exposure heads 30.

As illustrated in FIG. 4, a fiber-array light source 38, a lens system 40 and a mirror 42 are arranged in this order on the light receiving side of the DID 36. The fiber-array light source 38 includes a laser emission portion in which light emission ends (light emission spots) of optical fibers are arranged in a row along a direction which corresponds to the longitudinal direction of an exposure area 32. The lens system 40 corrects laser beams emitted from the fiber-array light source 38 and condenses the corrected laser beams onto the DMD 36. The mirror 42 reflects the laser beams which have been transmitted through the lens system 40 toward the DMD 36. In FIG. 4, the lens system 40 is schematically illustrated.

As illustrated in detail in FIGS. 5A and 5B, the lens system 40 includes a pair 44 of combination lenses, a pair 46 of combination lenses and a condensing lens 48. The pair 44 of combination lenses collimates the laser beam emitted from the fiber-array light source 38. The pair 46 of combination lenses corrects the collimated laser beam so that the light amount of the laser beam is evenly distributed. The condensing lens 48 condenses the laser beam, of which the distribution of the light amount has been corrected, onto the DMD 36.

Further, a lens system 50 is placed on a light reflection side of the DMD 36. The lens system 50 forms an image on an exposure surface 12A, which is an image drawing surface of the photosensitive material 12, with the laser beam reflected by the DMD 36. The lens system 50 includes two lenses 52 and 54 which are arranged so that the DMD 36 and the exposure surface 12A (hereinafter, reference numeral 12A will be omitted) of the photosensitive material 12 have a conjugate relationship.

In the present embodiment, the laser beam emitted from the fiber-array light source 38 is substantially magnified 5 times. After the laser beam is magnified, the light beam reflected by each of the micromirrors of the DMD 36 is narrowed to approximately 5 μm by the lens system 50.

As illustrated in FIG. 6, the DMD 36 is a mirror device in which a great number of micromirrors 58, each forming a pixel, is arranged on an SRAM (static random access memory) cell (memory cell) 56. The micromirrors 58 are arranged in a grid shape. In the present embodiment, a DMD in which micromirrors 58 of 1024 columns×768 rows are arranged is used. However, it is assumed that among the micromirrors 58 of 1024 columns×768 rows, only micromirrors of 1024 columns×256 rows can be driven by the controller 160 connected to the DMD 36, in other words, only micromirrors of 1024 columns×256 rows can be used by the controller 160. The micromirrors of 1024 columns×256 rows form a pixel array including a great number of usable pixels. A data processing speed of the DMD 36 is limited and a modulation speed per line is proportional to the number of micromirrors which are utilized. Therefore, if only a part of the micromirrors is utilized, as described above, the modulation speed per line becomes higher. Each of the micromirrors 58 is supported by a post. Further, a high reflectance material, such as aluminum, is deposited on the surface of each of the micromirrors 58 by vapor deposition. In this embodiment, the reflectance of each of the micromirrors 58 is higher than or equal to 90%, and an arrangement pitch of the micromirrors is 13.7 μm in both vertical and horizontal directions. The SRAM cell 56 is arranged through the support post, which has a hinge and a yoke. The SRAM cell 56 is a silicon-gate CMOS (complimentary metal oxide semiconductor), and the CMOS is manufactured in a general production line of semiconductor memories. Further, the SRAM cell 56, as a whole, has a monolithic (single-piece) structure.

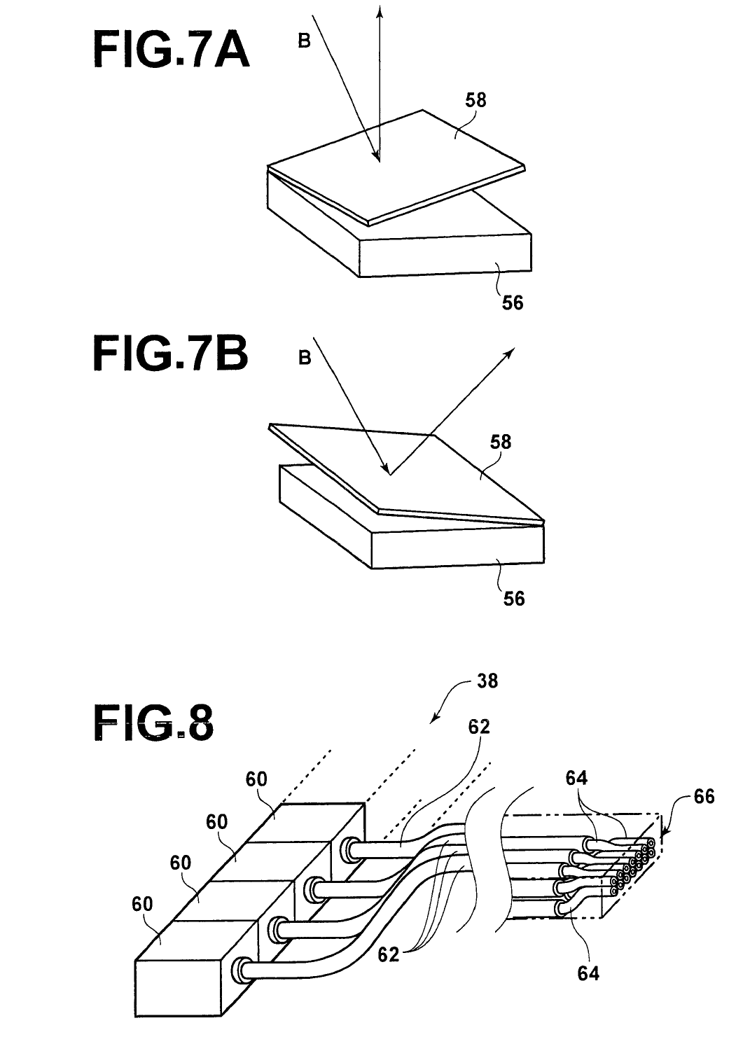

When an image signal is stored in the SRAM cell 56 of the DMD 36, each of the micromirrors 58 supported by the support posts is inclined with respect to a diagonal line of each of the micromirrors 58. The image signal is a signal representing the density of each spot, which forms a desired two-dimensional pattern, by binary values. Each of the micromirrors 58 is inclined either at +α degrees or at −α degrees (for example, ±10 degrees) with respect to a substrate on which the DMD 36 is placed. In FIG. 7A, the micromirror 58 is on, and the micromirror 58 is inclined at +α degree. In FIG. 7B, the micromirror 58 is off, and the micromirror 58 is inclined at −α degree. In the DMD, the angle of inclination of a micromirror 58 for each pixel of the DMD 36 is controlled, based on an image signal, as illustrated in FIG. 6. Accordingly, a laser beam B which has entered the DMD 36 is reflected to a direction corresponding to the inclination angle of each of the micromirrors 58.

FIG. 6 is a diagram illustrating a partial enlarged view of the DMD 36. In the example illustrated in FIG. 6, each of the micromirrors 58 is controlled to incline at +α degrees or −α degrees. The ON/OFF of each of the micromirrors 58 is controlled by the controller 160 which is connected to the DMD 36. Further, a light absorption material (not illustrate) is provided in the propagating direction of the laser beam B reflected by a micromirror 58 which is off.

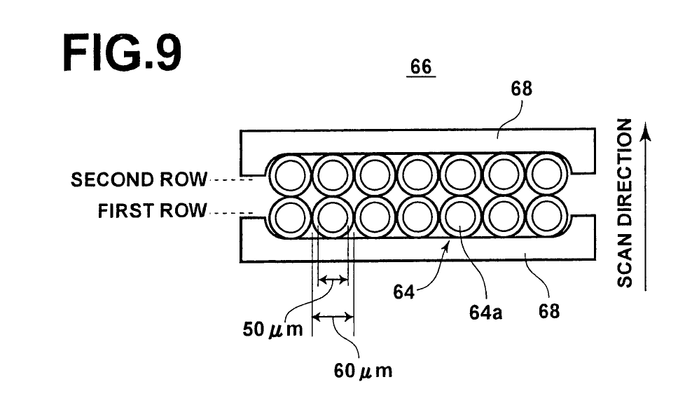

The fiber-array light source 38 includes a plurality of laser modules 60 (for example, 14 modules), as illustrated in FIG. 8. Each of the laser modules 60 is connected to an end of a multi-mode optical fiber 62. A multi-mode optical fiber 64, of which the cladding diameter is smaller than that of the multi-mode optical fiber 62, is connected to the other end of the multi-mode optical fiber 62. As illustrated in FIG. 9 in detail, a laser emission portion 66 is formed by arranging the end of each of the multi-mode optical fibers 64, which is opposite to the end thereof connected to the multi-mode optical fiber 62. Seven ends of the multi-mode optical fibers 64 are arranged in a row along a direction perpendicular to the scan direction and two rows, each including seven ends, are arranged to form the laser emission portion 66.

The laser emission portion 66 is formed by the end of each of the multi-mode optical fibers 64. Further, the laser emission portion 66 is fixed by being sandwiched between two support plates 68, each having a flat surface, as illustrated in FIG. 9. It is preferable that a transparent protective plate, such as glass, is provided on the surface of the light emission ends of the multi-mode optical fibers 64 to protect the light emission ends. The density of light at the light emission end of each of the multi-mode optical fibers 64 is high. Therefore, dust particles are easily collected by the light emission end and the condition of the light emission end tends to easily deteriorate. If the protective plate, as described above, is provided, it is possible to prevent adhesion of dust particles to the surface of the end. Further, it is possible to delay deterioration.

Next, variance in the inclination angle of the two-dimensional pixel array and its influence will be described.

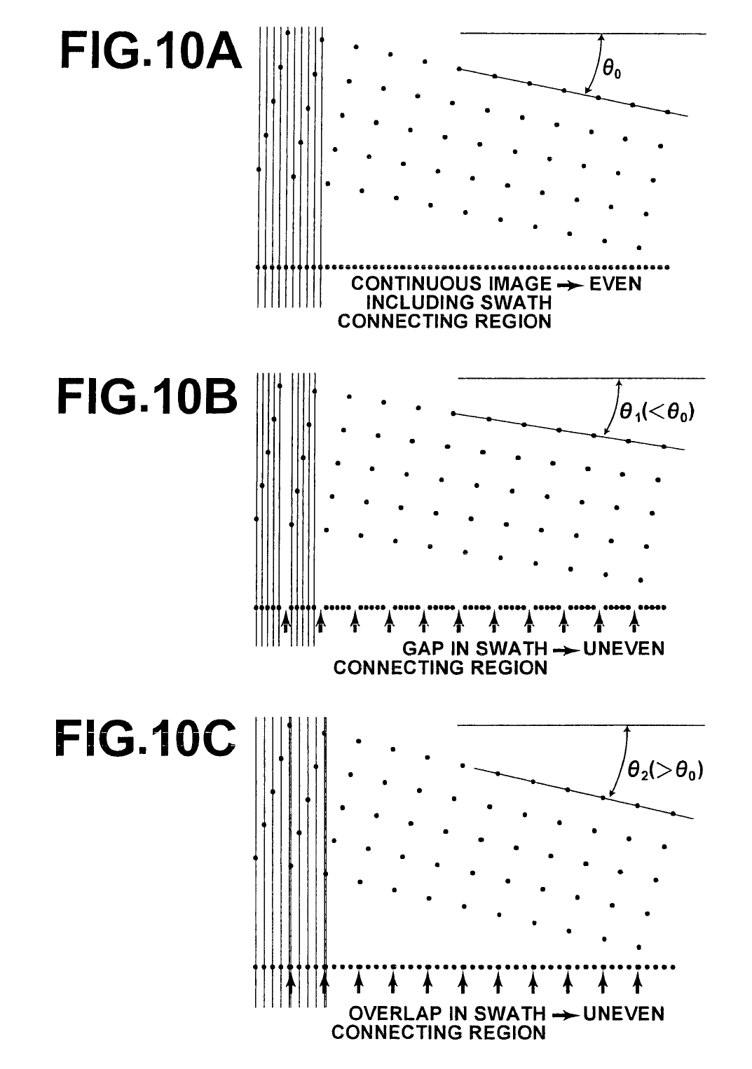

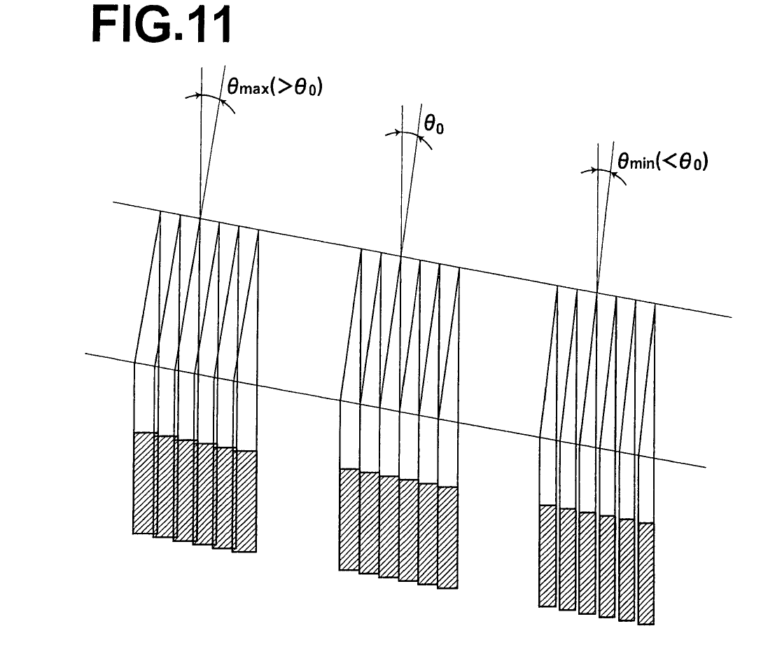

FIG. 10A is a diagram illustrating an image (drawn image) on an exposure surface when the inclination angle of each pixel column in a pixel array is the same as a set inclination angle and an error in the inclination angle is not present. The pixel array is set in advance so as to incline at a set inclination angle θ₀ with respect to the scan direction. If the actual inclination angle is the same as the set inclination angle θ₀, no gap or overlap is generated in a region (swath connecting region) between a column (swath) extending in a scan direction and a column (swath) adjacent thereto in the two-dimensional pixel array. Therefore, the drawn image does not become uneven. Meanwhile, if the inclination angle of the pixel array is θ₁ (<θ₀), as illustrated in FIG. 10B, a gap is generated in the swath connecting region. Therefore, the drawn image becomes uneven. Further, in the example illustrated in FIG. 10C, the inclination angle of the pixel array is θ₂ (>θ₀). In this case, an overlap is generated in a region (swath connecting region) between the swaths. Therefore, the drawn image becomes uneven. In each of the examples illustrated in FIGS. 10B and 10C, the inclination angle is the same in the entire pixel array. In other words, a difference between the actual inclination angle and the set inclination angle is the same in the entire pixel array.

In the examples illustrated in FIGS. 10B and 10C, the inclination angle of the pixel array is the same in the entire pixel array. Therefore, an error of the actual inclination angle from the set inclination angle is the same in the entire pixel array. However, in some cases, the error may not be the same in the entire pixel array. For example, in FIG. 11, there is variance in the error of the inclination angle of the pixel array. In FIG. 11, the error is in the range from θ_{MAX} (>θ₀) to θ_{MIN} (<θ₀). If there is variance in the error, an “overlap” or a “gap” is generated in a swath connecting region. Therefore, it is impossible to specify a single factor which causes unevenness of a single drawn image.

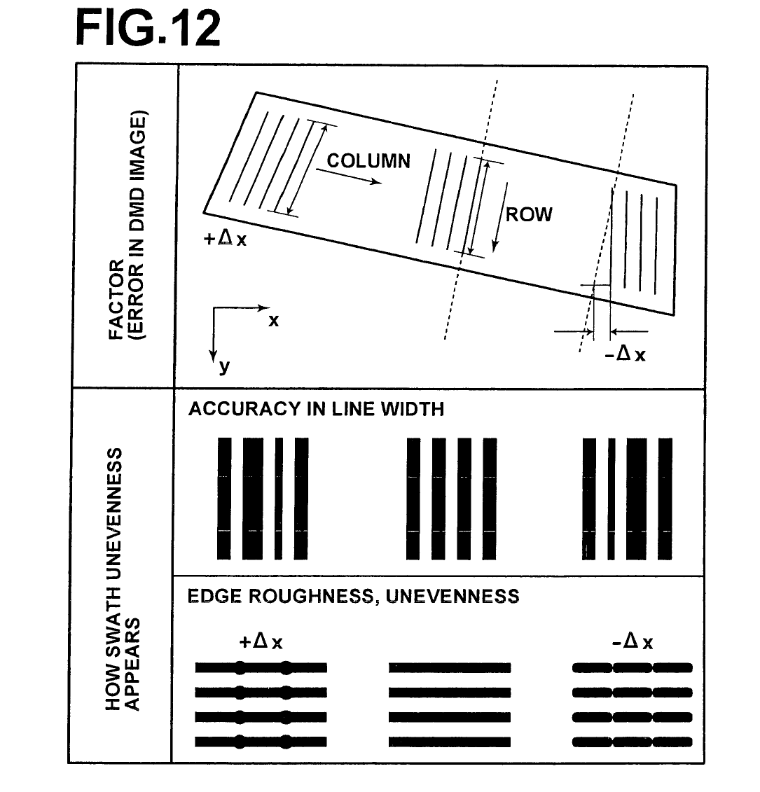

Specifically, unevenness in the swath connecting region appears as variation in line widths in a drawn image, as illustrated in FIG. 12.

The distortion in the inclination angle, as described above, is caused by factors, such as various kinds of aberration of an optical system between the DMD 36 and the exposure surface, a deviation in alignment, a distortion of the DMD 36, itself, and an error in arrangement of the micromirrors.

In the present embodiment, an apparatus and a method for suppressing unevenness in single exposure (N=1) will be described.

It is assumed that an angle which is slightly greater than an angle θ_{ideal} is adopted as the set inclination angle θ of each of the exposure heads 30, in other words, as the set inclination angle θ of each of the DMD's 36. The angle θ_{ideal} is an angle at which exact single exposure is performed in an ideal state by using usable micromirrors 58 of 1024 columns×256 low. The ideal state is a state, as designed, in which there is no error in the mounting angle of each of the exposure heads 30. The angle θ_{ideal} is given by the following arithmetic expression:

s·p sin θ_{ideal}=Nδ,

where the number of times of N-tuple exposure is N, the number of usable micromirrors 58 constituting each pixel column is s, a pixel pitch in the pixel column direction of the usable micromirrors 58 is p, and a pixel column pitch of the usable micromirrors 58 in a direction perpendicular to a scan direction is δ. The phrase “pixel column pitch” means a pitch between columns of pixels. In the present embodiment, the DMD 36 includes a great number of micromirrors 58 which are arranged to form a rectangular grid, as described above. In the DMD 36, an arrangement pitch in the horizontal direction is the same as that in the vertical direction. Further, the following arithmetic expression is satisfied:

p·cos θ_{ideal}=δ.

Therefore, the following arithmetic expression is obtained:

s·tan θ_{ideal}=N.

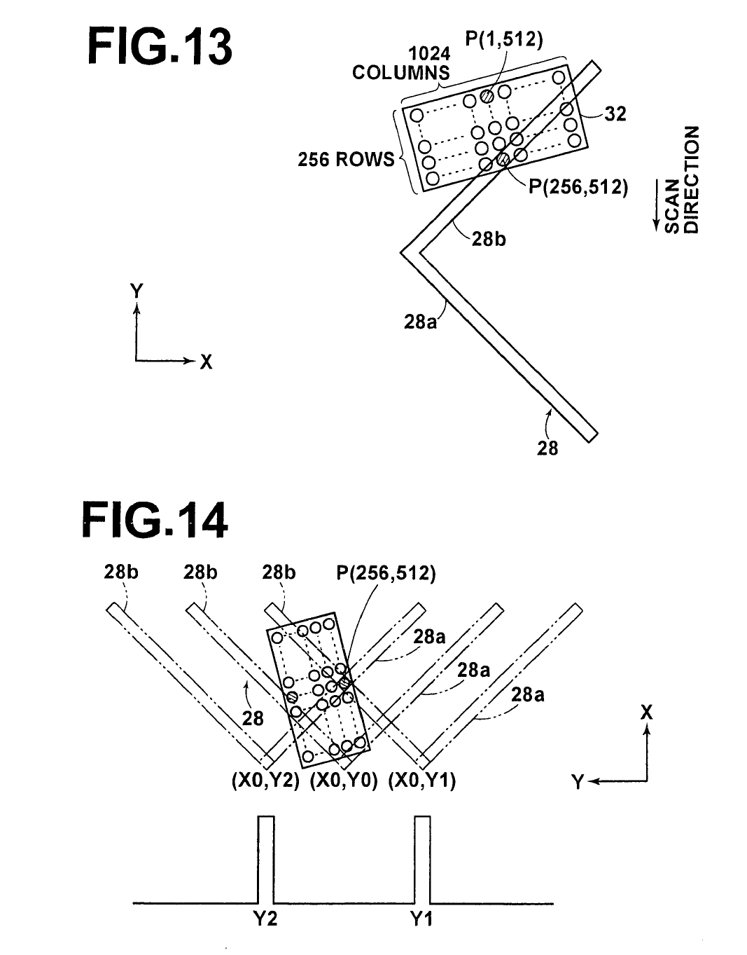

In the present embodiment, processing is performed to reduce unevenness which is generated on the exposure surface, as described above. The position detection unit 120, which includes a pair of a slit 28 and a photo-detector 122 and the position specifying unit 126, as described above, is used and the position of a light spot projected onto the exposure surface is detected for each of the exposure heads 30. The light spot is a pixel image drawing spot, which has been drawn on the image drawing surface. Then, the operation apparatus 130 which is connected to the position specifying unit 126 specifies an actual inclination angle θ′ of an image drawing column including the light spots, in other words, pixel image drawing spots. The operation apparatus 130 performs pixel-to-utilize selection processing for selecting, based on the actual inclination angle θ′, micromirrors which are utilized in actual exposure processing. The processing for specifying the actual inclination angle θ′ and the processing for selecting the pixel-to-utilize will be described with reference to FIGS. 13 and 14.

FIG. 13 is a top view illustrating a positional relationship between an exposure area 32 by a single DMD 36 and a slit corresponding to the exposure area 32. As already described, the size of the slit 28 is sufficiently large to cover the width of the exposure area 32.

In the present embodiment, three image drawing spot columns are selected as representative image drawing spot columns. The exposure area 32 is substantially divided into three equal regions. Then, an image drawing spot column approximately at the center (170th column, 512th column and 854th column) in each of the three regions is selected as a representative image drawing spot column. It is not necessary that the number of image drawing spot columns selected as the representative image drawing spot columns is three. Alternatively, a pixel column in the pixel array of the exposure head may be appropriately selected and an image drawing spot column on the exposure surface, which corresponds to the pixel column, may be selected as a representative image drawing spot column.

Here, a light spot may be projected onto the exposure surface by setting a single micromirror in the pixel array to ON and the position of the light spot may be obtained as a “position which will become an image drawing spot”. Then, the position of a light spot may be obtained in a similar manner for another micromirror on the same pixel column. Then, an image drawing spot column may be obtained as a light spot column, which is a line connecting the two light spots. Light spots projected onto the exposure surface are pixel image drawing spots drawn on the image drawing surface by the exposure head 30. Therefore, the light spot column formed by the light spots projected onto the exposure surface is a “column which will become an image drawing spot column when image drawing is actually performed”. A method for obtaining the image drawing spot column as a light spot column will be used in the following description.

In the present embodiment, an angle formed by the direction of each of the representative image drawing spot columns, as described above, and the scan direction of the exposure head is measured as an actual inclination angle θ₁′, θ₂′ or θ₃′, respectively. Specifically, a micromirror in the first row, 170th column of the DMD 36 and a micromirror in the 256th row, 170th column of the DMD 36 are set to ON. Then, the position of light spot P_{A1} (1, 170), which corresponds to the micromirror in the first row, 170th column, and the position of light spot P_{A2} (256, 170), which corresponds to the micromirror in the 256th row, 170th column, are detected. Then, an angle formed by a straight line connecting the two light spots and the scan direction is specified as the actual inclination angle θ₁′. Similarly, the actual inclination angle θ₂′ is specified by detecting the position of light spot P_{B1} (1, 512) and the position of light spot P_{B2} (256, 512). Similarly, the actual inclination angle θ₃′ is specified by detecting the position of light spot P_{C1} (1, 854) and the position of light Spot P_{C2} (256, 854).

FIG. 14 is a diagram for explaining a method for detecting the position of light Spot P_{B2} (256, 512). First, a micromirror at the position (256, 512) in the pixel array is set to ON and the stage 14 is slowly moved. The stage 14 is driven by the stage drive apparatus 124. Then, the slit 28 relatively moves toward the Y direction. The slit 28 is positioned at an arbitrary position so that the light spot P_{B2} (256, 512) is positioned between the slit 28a on the upstream side and the slit 28b on the downstream side. In this state, the coordinate of the intersection of the slit 28a and the slit 28b is defined as (X0, Y0). The value of the coordinate (X0, Y0) is determined based on a distance of movement to the above position by the stage 14, represented by a drive signal provided for the stage 14, and the position of the slit 28 with respect to the X direction. The position of the slit 28 with respect to the X direction is a known position. Then, the value of the coordinate (X0, Y0) is recorded.

Next, the stage 14 is moved and the slit 28 is relatively moved toward the right side of the Y axis in FIG. 14. As indicated with double-dot dashed lines in FIG. 14, when light from the light spot P_{B2} (256, 512) is transmitted through the slit 28b on the left side and detected by a photo-detector, the stage 14 is stopped. The coordinate of the intersection of the slit 28a and the slit 28b in this state is recorded as (X0, Y1).

Next, the stage 14 is moved and the slit 28 is relatively moved toward the left side of the Y axis in FIG. 14. As indicated with double-dot dashed lines in FIG. 14, when light from the light spot P_{B2} (256, 512) is transmitted through the slit 28a on the right side and detected by the photo-detector, the stage 14 is stopped. The coordinate of the intersection of the slit 28a and the slit 28b in this state is recorded as (X0, Y2).

Then, the coordinate (X, Y) of light spot P_{B2} (256, 512) is calculated by using the following arithmetic expressions:

X=X0+(Y1−Y2)/2; and

Y=(Y1+Y2)/2.

Similarly, the coordinate of light spot P_{B1}(1, 512) is determined. Then, an angle formed by the direction of a straight line connecting the light spot P_{B1} (1, 512) and the light spot P_{B2} (256, 512) and the scan direction is obtained. (The straight line is a light spot column which will become a “representative image drawing spot column” when actual image drawing is performed. Therefore, hereinafter, it is referred to as a “representative light spot column”.) Accordingly, the actual inclination angle θ₂′ is specified. Similarly, the actual inclination angle θ₁′ and the actual inclination angle θ₃′ are also specified.

Here, the position of each light spot, such as light spot P_{B1} and light spot P_{B2}, is detected by the position specifying unit 126, which is connected to the photo-detector 122. Specifically, the position specifying unit 126 obtains the position of each light spot by using the method, as described above. The position specifying unit 126 obtains the position based on information representing that the photo-detector 122 has detected each of the light spots and information representing the position of the stage 14 when each of the light spots has been detected. The information representing the position of the stage 14 is input from the controller 160.

Then, the operation apparatus 130 receives the information representing the position of each of the light spots and specifies the actual inclination angle θ′. Further, the operation apparatus 130 performs pixel-to-utilize selection processing for selecting, based on the specified actual inclination angle θ′, a micromirror which is actually utilized in actual exposure processing.

When the position detection unit 120 performs processing for detecting a position, the stage 14 is driven by the stage drive apparatus 124, which is controlled by the controller 160, and moved along the guides 20. Therefore, the stage drive apparatus 124, the guides 20, the stage 14, the controller 160 and the like are also components which form the position detection unit 120.

The operation apparatus 130 uses the specified actual inclination angle θ′ and obtains a natural number Tₙ which is closest to a value tₙ which satisfies the following arithmetic expression:

tₙ·tan θₙ′=N.

For example, a natural number T₂ is obtained for the actual inclination angle θ₂′. Processing for selecting micromirrors in the first row through the T-th row in the DMD 36 is performed. The micromirrors in the first row through the T-th row are selected as micromirrors which are actually utilized during exposure of a region in the vicinity of a corresponding representative light spot column. For example, in the present embodiment, micromirrors from the first row through the T₂-th row are selected as micromirrors which are utilized in exposure. The micromirrors from the first row through the T₂-th row are selected in a region of which the center is a representative light spot column connecting light spot P_{B1} (1,512) and light spot P_{B2} (256,512). The region of which the center is the representative light spot column connecting the light spot P_{B1} (1,512) and the light spot P_{B2} (256,512) is a region from the 342nd column through the 683rd column.

Similarly, a natural number T₁ is obtained based on the actual inclination angle θ₁′. In a region (from the first column through the 341st column), of which the center is a representative light spot column connecting light spot P_{A1}(1, 170) and light spot P_{A2} (256, 170), micromirrors from the first row through the T₁-th row are selected as micromirrors which are utilized in exposure.

Further, a natural number T₃ is obtained based on the actual inclination angle θ₃′. In a region (from the 684th column through the 1024th column), of which the center is a representative light spot column connecting light spot P_{C1} (1, 854) and light spot P_{C2} (256, 854), micromirrors from the first row through the T₃-th row are selected as micromirrors which are utilized in exposure.

Setting is made so that micromirrors other than the selected micromirrors are not utilized in exposure. Specifically, a signal for setting the inclination angle of a micromirror constantly to OFF is sent to each of the micromirrors which are not utilized.

For example, in the present embodiment, if each of the actual inclination angles θ₁′, θ₂′ and θ₃′ satisfies the following relationship with the set inclination angle θ₀:

θ₁′>θ₀;

θ₂′=θ₀; and

θ₃′<θ₀,

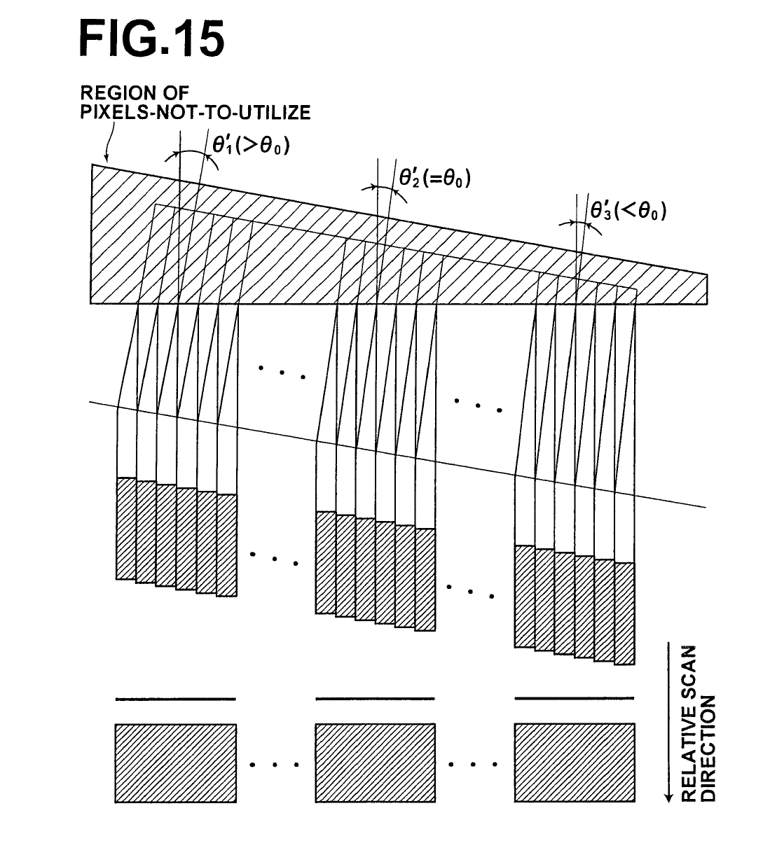

a region, as illustrated in FIG. 15, is set as a region of pixels-not-to-utilize.

Specifically, information representing the micromirrors which have been selected by the operation apparatus 130, and which are actually utilized in exposure, is input to a setting changing means 150. (Here, the information is also information representing pixels which are not utilized.) The setting changing means 150 changes the setting of the controller 160 so that only the micromirrors which have been selected as micromirrors to be actually utilized operate. After the setting of the controller 160 is changed, exposure is performed by being controlled by the controller 160, of which the setting has been changed. Accordingly, even if the inclination angle of each of the image drawing columns is not the same, a pixel-to-utilize is appropriately selected for the image drawing column. Therefore, it is possible to suppress an influence of a distortion of the exposure surface.

The pixel-to-utilize designation means 140 and the setting changing means 150 may be integrated as a pixel-to-utilize setting means. The pixel-to-utilize setting means performs setting so that only the pixels-to-utilize operate among the usable pixels.

Further, a larger number of representative light spot columns may be selected and an actual inclination angle may be specified for each of the representative light spot columns. If the larger number of representative light spot columns is selected, a distortion in a drawn image can be more accurately corrected.

Here, the actual inclination angle of the representative light spot column may also be obtained by using the following method. Specifically, when a region in the vicinity of a representative light spot column is used as a representative region, an actual inclination angle (referred to as individual actual inclination angle) is specified for each column in a part or all of light spot columns in the representative region. Further, an average value of the individual actual inclination angles is regarded as the actual inclination of the representative region. Each of the light spot columns can be obtained by measuring the positions of at least two light spots on each of the columns. Alternatively, one of a median value, a maximum value and a minimum value of the individual actual inclination angles may be regarded as the actual inclination angle of the representative region. For example, if the minimum value of the individual actual inclination angles is used as the actual inclination angle of a representative region, it is possible to more effectively suppress unevenness generated by a gap in a swath connecting region in the representative region. Alternatively, if the maximum value of the individual actual inclination angles is used as the actual inclination angle of the representative region, it is possible to more effectively suppress unevenness generated by an overlap in the swath connecting region.

In the above embodiment, the operation apparatus 130 receives a detection result of the position of a light spot, obtained by use of the pair of the slit 28 and the photo-detector 122 and the position specifying unit 126. Then, the operation apparatus 130 obtains a plurality of actual inclination angles. Further, the operation apparatus 130 selects a pixel-to-utilize based on each of the actual inclination angles. In the above embodiment, an operation of the pixel-to-utilize designation unit 140, which is a pixel-to-utilize designation means, has been described. Alternatively, the pixel-to-utilize designation means may designate pixels-to-utilize which are utilized in N-tuple image drawing among the usable micromirrors without obtaining an actual inclination angle. Further, it is also within the scope of the present invention to cause the pixel-to-utilize designation means to function as a means for manually designating a micromirror to utilize by an operator. For example, reference exposure, which will be described later, is performed by using usable micromirrors and the operator visually checks the result of the reference exposure. Accordingly, the operator can designate the micromirror to utilize by checking unevenness in resolution or density.

An embodiment of the exposure apparatus according to the present invention and a modified example of the exposure apparatus when single (N=1) exposure is performed have been described in detail. Next, an advantageous effect of applying the method for setting the pixel-to-utilize to double (N=2) exposure will be described. Further, a modified example of the exposure apparatus for effectively suppressing unevenness in a drawn image in so-called multiple exposure will be described. The multiple exposure is exposure when N is greater than or equal to 2. In the following description, an exposure apparatus which has the same structure as the exposure apparatus 10, which was used in the explanation of single exposure, will be used unless otherwise specified. Further, it is assumed that the relationships, as given by the above arithmetic expressions, are also satisfied in multiple exposure.

In double exposure, an exposure pattern formed by odd-numbered columns and an exposure pattern formed by even-numbered columns are superimposed one on the other to form a single drawn image.

The method for selecting a pixel-to-utilize among the micromirrors so as to solve a so-called “angle distortion” has been described for the example of single exposure. The “angle distortion” is a distortion caused by an error in the inclination angle of the column direction of the micromirrors 58 in the DMD 36. In the example showing selection of pixels-to-utilize, three representative light spot columns are selected. Further, the actual inclination angle of each of the three representative light spot columns is specified. Then, a pixel row to utilize is designated, based on the specified actual inclination angle, for each of the representative regions. The representative region is a region in the vicinity of each of the representative light spot columns. In the method, as described above, if the number of selected representative light spot columns is smaller, the calculation amount required till designation of the pixels-to-utilize is smaller. However, if the number of representative light spot columns is smaller, an influence of distortion in a drawn image, which is caused by variance in the inclination angles in each representative region, might not be sufficiently reduced in some cases.

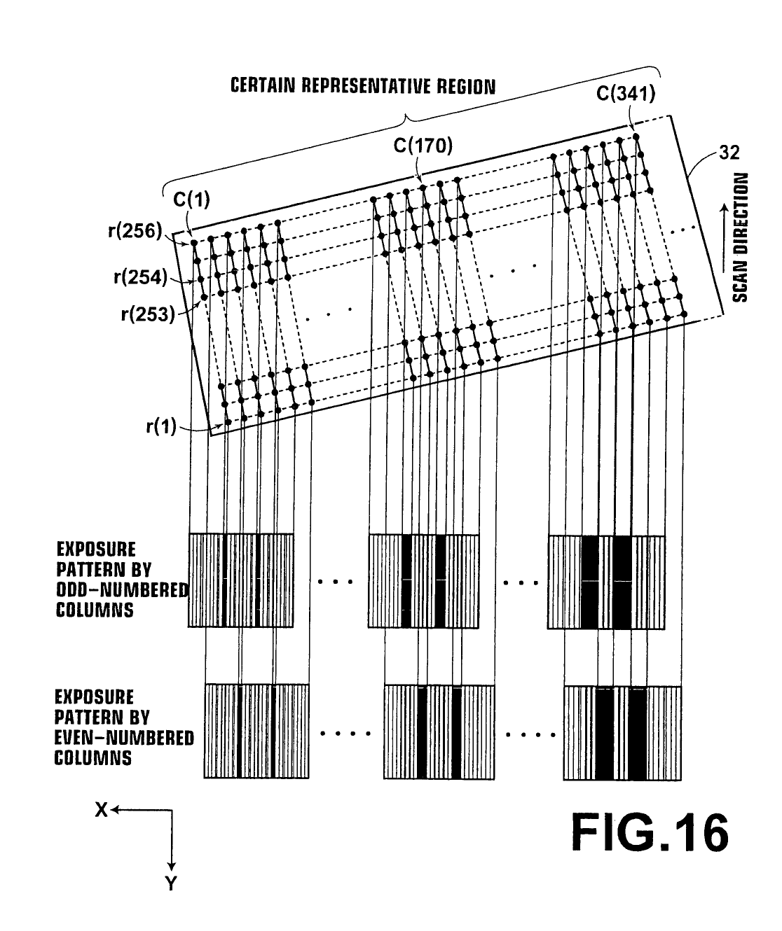

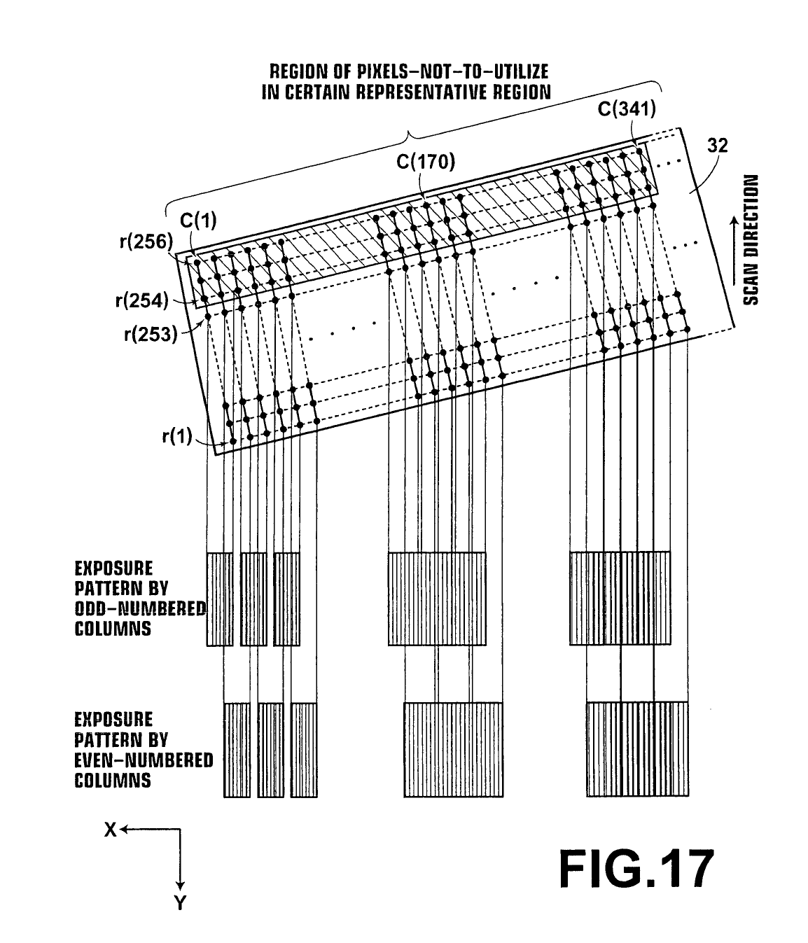

For example, in a representative region illustrated in FIG. 16, if pixels-to-utilize are not designated, a gap and an overlap are generated in swath connecting regions. When a “region of pixels-not-to-utilize” is set for the representative region, as illustrated in FIG. 17, unevenness in a drawn image, which is caused by an angle distortion, is reduced. However, in each of an exposure pattern formed by odd-numbered columns and an exposure pattern formed by even-numbered columns, “a portion in which exposure is insufficient (a region in which a gap is generated in a swath connecting region)” and “a portion in which exposure is redundant (a region in which an overlap is generated in the swath connecting region)” are slightly generated. In the example illustrated in FIG. 17, a light spot column which is approximately at the center of the representative region is used as a representative light spot column. Then, the number of rows of pixels-to-utilize is obtained based on the actual inclination angle of the representative light spot column. Further, a region of pixels-not-to-utilize is determined in the representative region. The region of pixels-not-to-utilize includes a certain number of rows in the representative region. Therefore, unevenness in a swath connecting region is slightly generated in the vicinity of each of the edges of the representative region, which are apart from the light column at the center thereof (in FIG. 17, each of the exposure pattern on the left side and the exposure pattern on the right side).

As described above, if exposure is performed only once, there is a possibility that slight unevenness remains. However, when double exposure is performed, the exposure pattern formed by the odd-numbered columns and the exposure pattern formed by the even-numbered columns are superimposed one on the other. Therefore, the exposure pattern formed by the odd-numbered columns and the exposure pattern formed by the even-numbered columns supplement each other. Hence, the unevenness in the swath connecting region in each of the exposure patterns is reduced and it becomes unnoticeable. Therefore, if a smaller number of representative light spot columns is selected during selection of pixels-to-utilize, it is possible to reduce the calculation amount for selecting the pixels-to-utilize. Further, it is possible to achieve an advantageous effect of reducing the unevenness by selecting the pixels-to-utilize. Additionally, it is possible to achieve an advantageous effect of reducing unevenness by superimposing patterns in multiple exposure. Hence, it is possible to draw a high quality image.

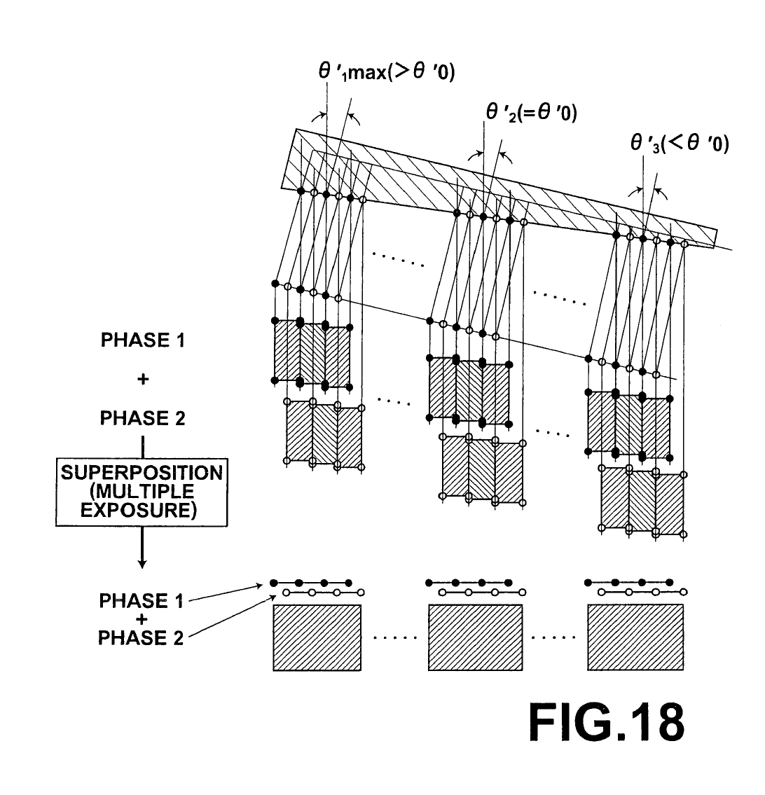

Specifically, in multiple exposure, when a figure distortion is present, an influence of the distortion can not be sufficiently suppressed in some cases (FIG. 17). In that case, if pixels-to-utilize are selected, based on an actual inclination angle, in a manner similar to the processing in single exposure, it is possible to obtain a more accurate image. Specifically, as illustrated in FIG. 18, when actual inclination angles are θ₁′ (>θ₀), θ₂′ (=θ₀) and θ₃′ (<θ₀), the number of pixels-to-utilize is selected based on variance in the actual inclination angles. If the number of pixels-to-utilize is selected in this manner, it is possible to suppress generation of unevenness or generation of a gap in a swath connecting region in an image which is drawn in each phase (for example, each of a pattern formed by odd-numbered columns and a pattern formed by even-numbered columns). Therefore, in multiple exposure, in which an image drawn in each of the phases is superimposed one on another, it is possible to obtain a more accurate image.

If the pixels-to-utilize are determined by selecting a larger number of representative light spot columns, and further if multiple exposure is performed, the quality of the drawn image becomes even higher.

Next, reduction of unevenness in a drawn image, which is caused by factors other than the angle distortion, will be described.

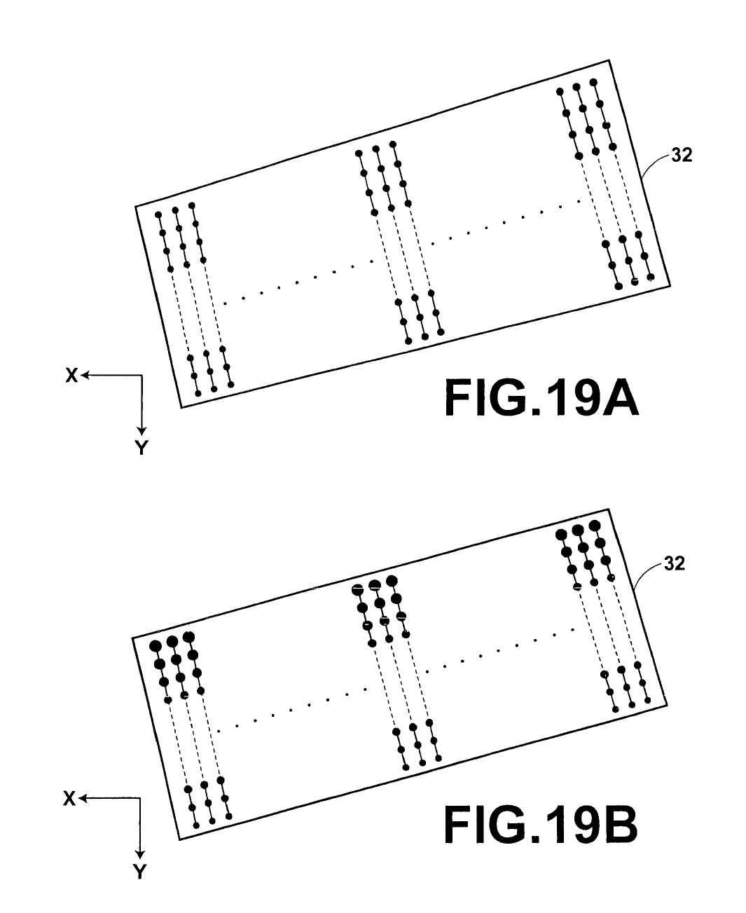

Besides the angle distortion, the unevenness of the drawn image is caused by a “magnification distortion” (FIG. 19A). The “magnification distortion” is generated when a light beam from each of the micromirrors 58 of the DMD 36 reaches the exposure area 32 on the exposure surface at a different magnification ratio from each other. Further, the unevenness of the drawn image is also caused by “beam diameter locality” (FIG. 19B). The “beam diameter locality” is a state in which a light beam from each of the micromirrors 58 of the DMD 36 reaches the exposure surface at a different beam diameter from each other. The magnification distortion and the beam diameter locality are mainly caused by various kinds of aberration of an optical system between the DMD 36 and the exposure surface and a deviation in alignment. Further, the unevenness of the drawn image is also caused by “light amount locality”. The “light amount locality” is a state in which a light beam emitted from each of micromirrors 58 of the DMD 36 reaches the exposure area 32 on the exposure surface at a different light amount from each other. The light amount locality is caused by various kinds of aberration and a deviation in alignment. The light amount locality is also caused by position dependency of the transmittance of an optical element (for example, the lenses 52 and 54 in FIG. 5, each of which is a single lens) between the DMD 36 and the exposure surface. The light amount locality is also caused by locality of the light amount of lighting which illuminates the DMD 36.

Unevenness in a drawn image, which is generated by these kinds of distortion, can be reduced by selecting pixels-to-utilize. Additionally, the unevenness can be reduced by superimposing exposure patterns by performing double exposure.

In a modified example of the exposure apparatus 10, when N is greater than or equal to 2, reference exposure may be performed by using only micromirrors which constitute pixel columns having (N−1) column intervals therebetween from among the usable micromirrors. Alternatively, reference exposure may be performed by using only micromirrors, of which the number corresponds to 1/N of the total number of pixels, and which constitute a group of pixel rows which are adjacent to each other. The reference exposure is performed so that a state close to ideal single exposure is achieved. Then, micromirrors which are not utilized in actual exposure may be specified among the micromirrors which were utilized in the reference exposure. Specifically, if the micromirrors which are not utilized in actual exposure are specified, it is possible to specify micromirrors which are utilized in actual exposure among the micromirrors. The micromirrors are pixels utilized in the reference exposure.

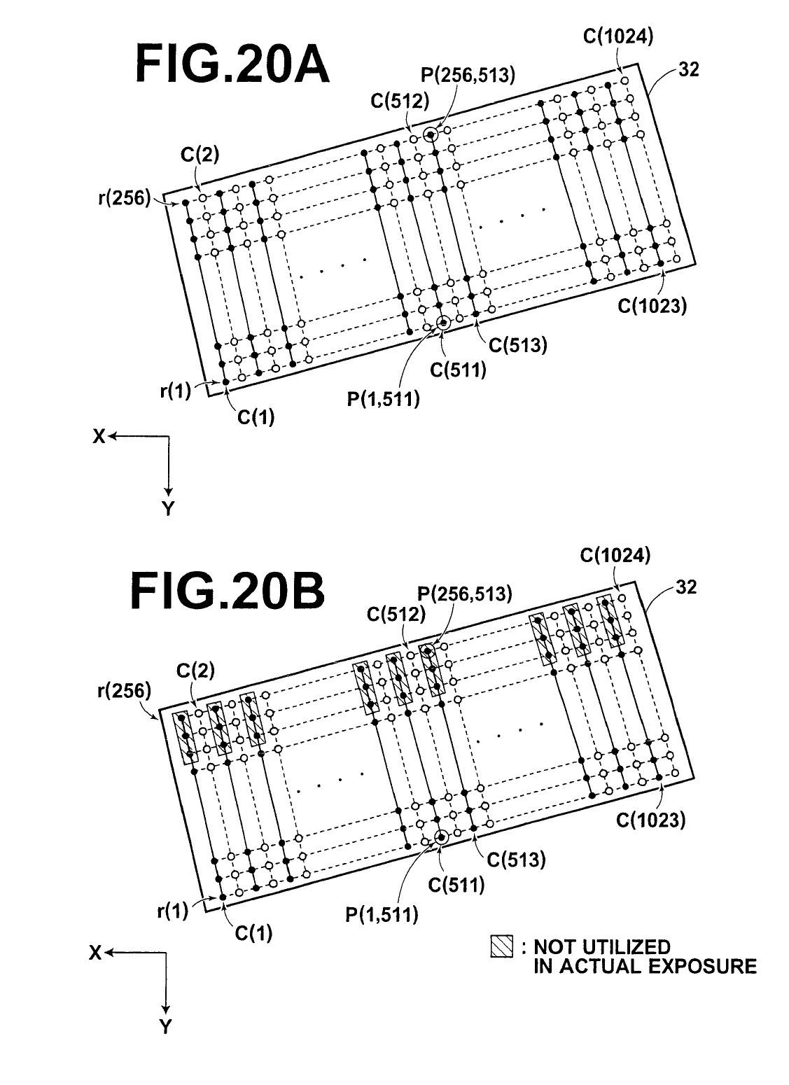

FIGS. 20A and 20B are diagrams for explaining an example of reference exposure. In the example illustrated in FIGS. 20A and 20B, N is greater than or equal to 2 and reference exposure is performed by using only micromirrors which constitute pixel columns having (N−1) column intervals therebetween. In this example, it is assumed that actual exposure is double exposure. Therefore, N=2. First, reference exposure is performed by using only the micromirrors corresponding to odd-numbered light spot columns which are indicated with solid lines in FIG. 20A, and a result of the reference exposure is output as a sample. Then, an operator visually checks unevenness in resolution or density based on the output result of the reference exposure. The operator also estimates an actual inclination angle. Accordingly, the operator can designate micromirrors which are utilized in actual exposure so that unevenness in resolution or density is minimized in actual exposure. For example, micromirrors other than the micromirrors corresponding to the shaded light spot columns in FIG. 20B can be designated as micromirrors which are actually utilized in actual exposure among the micromirrors which constitute odd-numbered pixel columns. Reference exposure may be separately performed on micromirrors in even-numbered pixel columns in a similar manner to designate micromirrors which are utilized in actual exposure. Alternatively, the same pattern as the pattern used for the odd-numbered pixel columns may be used for the even-numbered columns. Since the micromirrors which are utilized in actual exposure are designated, as described above, it is possible to perform double exposure which is close to ideal double exposure in actual exposure in which both the odd-numbered micromirror columns and the even-numbered micromirror columns are used. The result of the reference exposure may be visually checked by the operator or mechanically analyzed. The phrase “micromirror column” means a column of micromirrors.

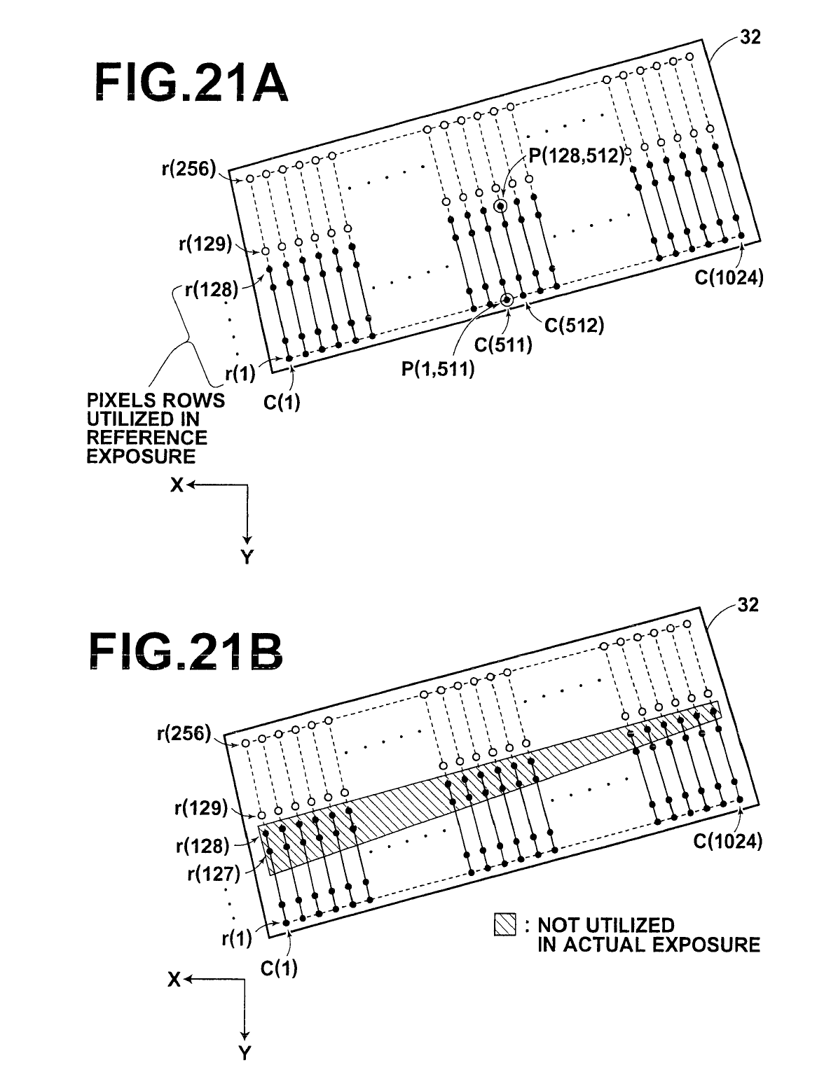

FIGS. 21A and 21B are diagrams for explaining another example of reference exposure. In the example illustrated in FIGS. 21A and 21B, N is greater than or equal to 2 and reference exposure is performed by using only micromirrors which correspond to 1/N of the total number of pixels, and which constitute a group of pixel rows which are adjacent to each other. In this example, it is assumed that actual exposure is double exposure. Therefore, N=2. First, reference exposure is performed by using only micromirrors corresponding to light spots from the first row through the 128th (=256/2) row, indicated with solid lines in FIG. 21A. Then, a result of the reference exposure is output as a sample. Then, an operator visually checks unevenness in resolution or density based on the output result of reference exposure. The operator also estimates an actual inclination angle. Accordingly, the operator can designate micromirrors which are utilized in actual exposure so that unevenness in resolution or density is minimized in actual exposure. For example, micromirrors other than the micromirrors corresponding to the shaded light spot columns, illustrated in FIG. 21B, can be specified as micromirrors which are actually utilized in actual exposure among the micromirrors in the first row through the 128th row. For the micromirrors in the 129th row through the 256th row, reference exposure may be separately performed to designate micromirrors which are utilized in actual exposure in a manner similar to the reference exposure performed for the micromirrors in the first row through the 128th row. Alternatively, the same pattern as the pattern for the micromirrors in the first row through the 128th row may be used for the micromirrors in the 129th row through the 256th row. Since the micromirrors which are utilized in actual exposure are designated, as described above, it is possible to perform double exposure which is close to ideal double exposure in actual exposure in which all of the micromirrors are utilized. The result of the reference exposure may be visually checked by the operator or mechanically analyzed.

In the descriptions of the embodiment and the modified examples thereof, the actual exposure was double exposure. However, it is not necessary that the actual exposure is double exposure. The actual exposure may be multiple exposure, in which the number of times of exposure is greater than or equal to two. Particularly, if actual exposure is one of triple exposure through septuple exposure or the like, it is possible to balance achievement of high resolution and reduction of unevenness in resolution and density.

Further, in the exposure apparatus in the above embodiment and the modified examples thereof, it is preferable that a mechanism for converting image data is provided. The mechanism for converting image data is a mechanism for converting the image data so that the size of a predetermined portion of a two-dimensional pattern, represented by the image data, becomes the same as that of a corresponding portion which can be formed by selected pixels-to-utilize. If the image data is converted in this manner, it is possible to form a highly accurate pattern, which is exactly the same as a desired two-dimensional pattern, on the exposure surface.

In the above description of the embodiment, a drive mechanism of each unit, such as a movement means, is omitted. A conventional drive mechanism can be used as the drive mechanism. For example, a ball rail system, an air-slide system or the like may be adopted as a slide mechanism. In the ball rail system, a movement base is moved on a rail. Further, a ball bearing, an air bearing or the like may be adopted as a rotation mechanism. A cam mechanism, a link mechanism, a rack pinion mechanism, a ball-screw/ball-bush mechanism, an air slide mechanism, a piston-cylinder mechanism or the like may be adopted as a drive force transmission mechanism. Further, a motor, an oil-pressure actuator, an air-pressure actuator or the like may be adopted as a drive source.

The exposure apparatus 10 is an example of an image drawing apparatus according to the present invention. The image drawing apparatus according to the present invention is an image drawing apparatus for drawing an image on an image drawing surface by performing N-tuple (N is a natural number greater than or equal to 2) image drawing to form a two-dimensional pattern represented by image data on the image drawing surface. The image drawing apparatus according to the present invention includes an image drawing head which has a pixel array. The pixel array includes a great number of usable pixels and the pixels are two-dimensionally arranged. The pixel array generates, based on the image data, a group of image drawing spots which forms the two-dimensional pattern. In other words, the pixel array is used to draw pixel image drawing spots representing the two-dimensional pattern on the image drawing surface. Further, the pixel column direction of the usable pixels forms a predetermined set inclination angle with respect to the scan direction of the image drawing head. The image drawing apparatus also includes a movement means, a pixel-to-utilize designation means and a setting changing means. The movement means relatively moves the image drawing surface in the scan direction with respect to the image drawing head. The pixel-to-utilize designation means designates pixels-to-utilize which are utilized in the N-tuple exposure among the great number of usable pixels included in the image drawing head. The setting changing means changes the setting so that only the designated pixels-to-utilize operate among the usable pixels included in the image drawing head.

The pixel array which generates a group of image drawing spots may be a great number of micromirrors arranged in a DMD. The great number of micromirrors, which are arranged as described above, emits a group of light fluxes based on an exposure or non-exposure state of each of the micromirrors. The group of light fluxes reflected by the micromirrors is a group of image drawing spots. The exposure surface is exposed to light by the group of light fluxes. In other words, pixel image drawing spots are drawn on the image drawing surface. Further, a pixel array other than the pixel array used in the present embodiment may be used. For example, the pixel array may be a pixel array which has a great number of nozzles which are arranged to perform an inkjet method. The great number of nozzles, which are arranged as described above, emits a group of inkjet droplets based on a drawing or non-drawing state of each of the nozzles. The group of inkjet droplets is a group of image drawing spots. The group of inkjet droplets is ejected from the great number of nozzles to draw an image on the image drawing surface. In other words, pixel image drawing spots are drawn on the image drawing surface.

The expression “the pixel column direction of the usable pixels forms a predetermined set inclination angle with respect to the scan direction of the image drawing head” refers to “the pixel column direction of the usable pixels and the relative scan direction of the image drawing surface with respect to the image drawing head form a predetermined set inclination angle”. Further, the predetermined set inclination angle can be represented by an angle formed by the extending direction of a pixel image drawing spot column and the scan direction of the image drawing surface with respect to the image drawing head. Pixel image drawing spots, which are drawn on the image drawing surface through each of pixels, constitute the pixel image drawing spot column.

Further, the pixel array in the image drawing head may be a pixel array for emitting each of light fluxes for drawing pixel image drawing spots representing a two-dimensional pattern on the image drawing surface. The pixel array may emit each of the light fluxes toward the image drawing surface so that each of the light fluxes corresponds to each of pixels constituting the pixel array. In this case, the pixel-to-utilize designation means obtains the position of a pixel in the pixel array based on the detection result of the position of a pixel image drawing spot. The pixel image drawing spot is formed on the image drawing surface by emitting each of the light fluxes.

Further, the pixel-to-utilize designation means may include a position detection means and a selection means. The position detection means may specify a redundant image drawing portion when predetermined N-tuple image drawing, as designed, has been performed. The redundant portion is a portion which corresponds to a connecting portion between pixel columns constituting the pixel array, and in which redundant image drawing has been performed. Alternatively, the position detection means may specify an insufficient image drawing portion when the predetermined N-tuple image drawing, as designed, has been performed. The insufficient image drawing portion is a portion which corresponds to a connecting portion between the pixel columns constituting the pixel array, and in which insufficient image drawing has been performed. Further, the selection means may specify pixels corresponding to the specified redundant image drawing portion and the specified insufficient image drawing portion. The selection means removes pixels corresponding to the redundant image drawing portion or adds a pixel or pixels corresponding to the insufficient image drawing portion. Accordingly, the selection means can select pixels-to-utilize which are utilized in actual exposure among the usable pixels in the pixel array so that the redundant image drawing portion and the insufficient image drawing portion are eliminated.

Further, the selection means may select pixels-to-utilize, which are utilized in actual exposure, in the pixel array so that the number of pixel image drawing spots corresponding to the redundant image drawing portion is minimized and so that pixel image drawing spots corresponding to the insufficient image drawing portion are eliminated.

Further, the selection means may select pixels-to-utilize, which are utilized in actual exposure, in the pixel array so that pixel image drawing spots corresponding to the redundant image drawing portion are eliminated and so that pixel image drawing spots corresponding to the insufficient image drawing portion are minimized.

Next, an example of the pixel-to-utilize designation means will be described. The pixel-to-utilize designation means designates pixels-to-utilize which are utilized in N-tuple image drawing among the usable micromirrors without obtaining the actual inclination angle θ′.

An example of the pixel-to-utilize designation means, which will be described below, may be applied to a case in which only micromirrors which constitute pixel columns having (N−1) column intervals therebetween are utilized from among the usable micromirrors to perform reference exposure. Alternatively, the example of the pixel-to-utilize designation means may be applied to a case in which only micromirrors, of which the number corresponds to 1/N of the total number of pixels, and which constitute a group of pixel rows which are adjacent to each other, are utilized among the usable micromirrors to perform reference exposure. Reference exposure is performed so that a state close to ideal single exposure is achieved. The example of the pixel-to-utilize designation means may be applied to a case in which micromirrors which are not utilized in actual exposure are designated among the micromirrors which have been utilized in reference exposure.

In the following description, a light spot which is projected onto an exposure surface, and which will become an image drawing spot when actual drawing is performed, is referred to as a pixel image drawing spot.

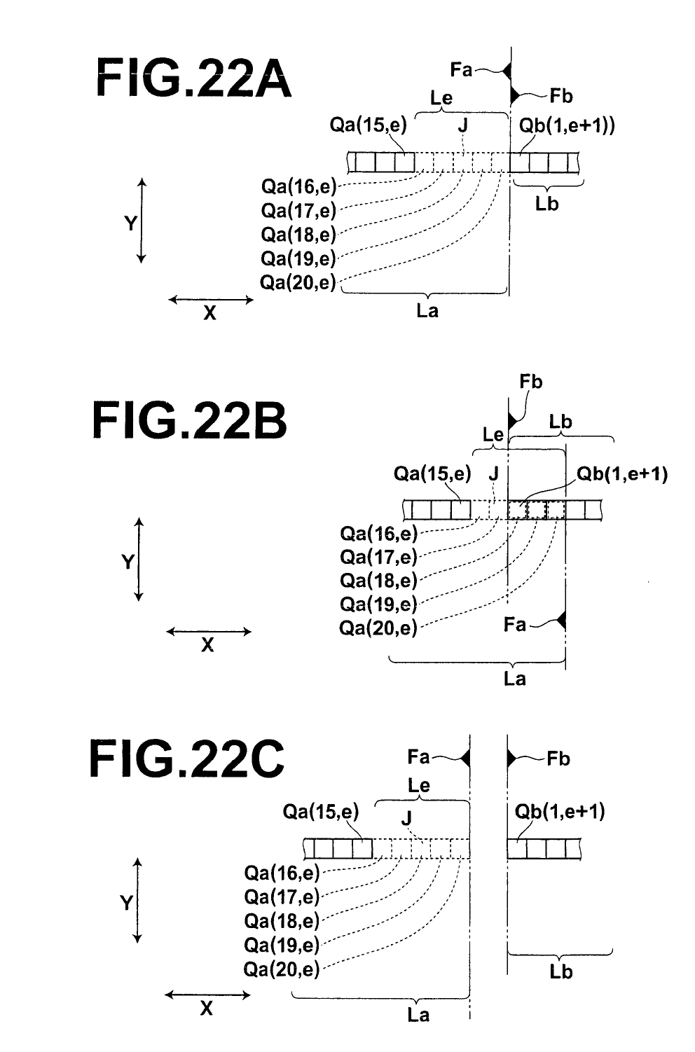

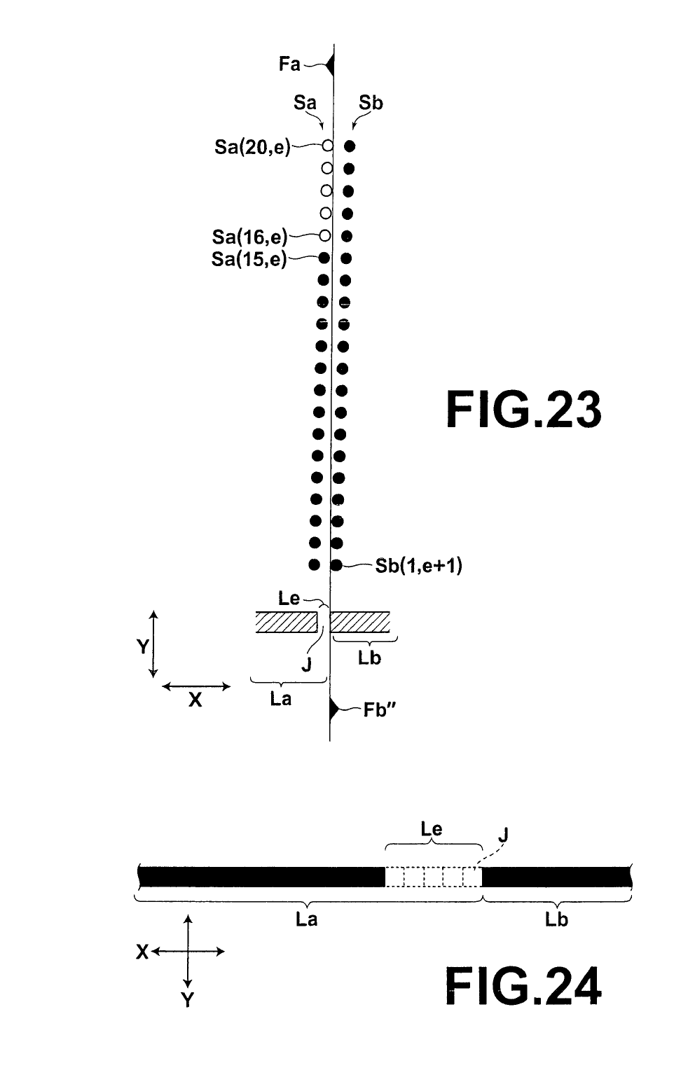

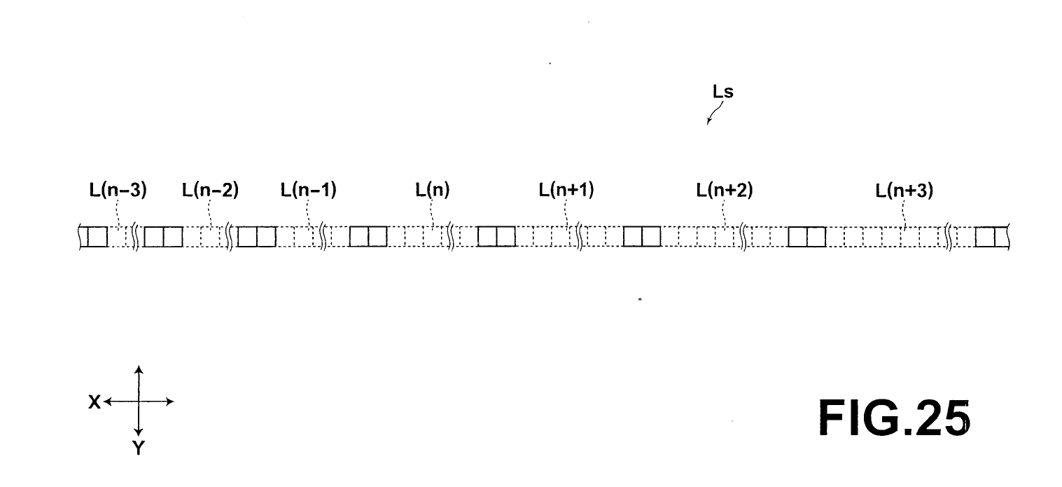

FIGS. 22A, 22B and 22C are diagrams, each illustrating a straight line which is formed by pixel image drawing spots, and which extends in the X direction. The pixel image drawing spots are spots drawn on the exposure surface when a deviation amount at a connecting portion is obtained. FIG. 22A is a diagram illustrating a state in which the deviation amount at a connecting portion is nil. FIG. 22B is a diagram illustrating a state in which a deviation is present in the connecting portion and image drawing is redundant. FIG. 22C is a diagram illustrating a state in which a deviation is present in the connecting portion and image drawing is insufficient. Further, FIG. 23 is a diagram illustrating a correspondence between the state of pixel columns and a straight line drawn by the pixel columns when a deviation amount in a connecting portion of micromirrors is obtained. The micromirrors constitute pixel columns which are adjacent to each other in the pixel array. FIG. 24 is a diagram illustrating a part of a straight line which extends in the direction of the X-axis when a deviation amount at the connecting portion is obtained. FIG. 25 is a diagram illustrating a reference scale. Here, FIG. 23 illustrates a state in which the deviation amount at the connecting portion is nil.

Micromirrors to utilize may be designated without obtaining the actual inclination angle θ′. In this method, a connecting portion between pixel columns which are adjacent to each other in a pixel array is used as a standard. The pixel array is a pixel array which is used in N-tuple exposure, and in which pixels are ideally arranged, as designed. Then, a deviation amount at the connecting portion, which is an actual deviation amount at the connecting portion between the pixel columns, is obtained. Further, the micromirrors to utilize (pixels-to-utilize) are designated based on the deviation amount at the connecting portion. The deviation amount at the connecting portion can be obtained based on the number of pixel image drawing spots of a portion in which image drawing is redundant. Alternatively, the deviation amount at the connecting portion can be obtained based on the number of pixel image drawing spots of a portion in which image drawing is insufficient.

When the deviation amount at the connecting portion is obtained, only the micromirrors which constitute pixel columns having (N−1) column intervals therebetween are utilized from among the pixels in an exposure head. The pixels are pixels, as designed, which are utilized in N-tuple exposure. Exposure is performed so that pixel image drawing spots which are formed by exposing the exposure surface to light form a straight line in the direction of the X-axis. The direction of the X-axis is a direction perpendicular to the scan direction (direction of the Y-axis). The thickness of the straight line, which is formed by exposing the exposure surface to light, and which extends in the direction of the X-axis, may be the size of one pixel image drawing spot. Alternatively, the thickness of the straight line may be greater than or equal to the size of two pixel image drawing spots. Hereinafter, an exposure method in which only micromirrors which constitute pixel columns having (N−1) column intervals therebetween are utilized in N-tuple exposure is referred to as “thinning reference exposure”. In the following description, it is assumed that the thinning reference exposure is performed.

Further, when image drawing is performed by an exposure head, exposure is performed so that micromirrors exceeding the number of pixel image drawing spots corresponding to a maximum conceivable deviation amount at a connecting portion (hereinafter, referred to as a “conceivable deviation amount at a connecting portion”) are not utilized. The conceivable deviation amount at a connecting portion is a deviation amount which can be conceived for a portion in which redundant image drawing will be performed. In other words, exposure is performed by setting the micromirrors exceeding the number of pixel image drawing spots corresponding to the conceivable deviation amount at a connecting portion to a non-exposure state. The number of micromirrors corresponding to the conceivable deviation amount at the connecting portion corresponds to that of conceivable pixel image drawing spots which will be drawn more than once in the scan direction on the exposure surface by pixels which are utilized in N-tuple exposure, and which constitute pixel columns which are adjacent to each other.

Next, a case in which an actual deviation amount at a connecting portion is obtained based on pixel image drawing spots drawn by the pixel columns which are adjacent to each other will be described with reference to FIGS. 22A, 22B, 22C and 23.

When a deviation amount at the connecting portion between pixel columns Sa and Sb, which are image drawing units, and which are different from each other, is measured, space adjacent pixels Sa (15, e) and Sb (1, e+1) are drawn without performing image drawing for space pixels Sa (16, e) through Sa (20, e). The space adjacent pixels Sa (15, e) and Sb (1, e+1) are pixels, each of which is adjacent to either side of the space pixels Sa (16, e) through Sa (20, e). The space pixels are a predetermined number of consecutive pixels which are arranged along the pixel column and which include a pixel or pixels at least in one of the pixel columns Sa and Sb. The number of the space pixels is five in this example. Further, the pixel column Sa and the pixel column Sb should be drawn so that they are adjacent to each other and an edge Fa of the pixel column Sa and an edge Fb of the pixel column Sb are positioned therebetween. Then, the number of pixel image drawing spots which can be inserted between pixel image drawing spots Qa (15, e) and Qb (1, e+1), which are drawn on the exposure surface by the space adjacent pixels Sa (15, e) and Sb (1, e+1), and the number of the space pixels Sa (16, e) through Sa (20, e) are compared with each other. Accordingly, a deviation amount at the connecting portion between the pixel column Sa and the pixel column Sb is obtained.

The state of the connecting portion, illustrated in FIG. 22A, corresponds to the state of the connecting portion, illustrated in FIG. 23. In both FIGS. 22A and 23, a deviation at a connecting portion is not present. FIG. 22B is a diagram illustrating a state in which redundant image drawing is performed, and in which a deviation is present at a connecting portion. FIG. 22C is a diagram illustrating a state in which insufficient image drawing is performed, and in which a deviation is present at a connecting portion.

The space pixels Sa (16, e) through Sa (20, e) are a predetermined number of pixels, as described above. The predetermined number is a number which is slightly greater than the conceivable deviation amount at the connecting portion. In the pixel column Sa, illustrated in FIG. 23, pixels indicated with white circles are pixels (micromirrors) with which exposure is not performed on the exposure surface. In FIG. 23, the other pixels, namely pixels indicated with black circles, are pixels (micromirrors) with which exposure is performed on the exposure surface.

The group of space pixel image drawing spots may be arranged only in the pixel image drawing spot column Qa. Alternatively, the group of space pixel image drawing spots may be arranged only in the pixel image drawing spot column Qb. Alternatively, the group of space pixel image drawing spots may be arranged so as to straddle the pixel image spot column Qa and the pixel image drawing spot column Qb.

A straight line which is drawn on the exposure surface, as described above, and which extends in the direction of the X-axis, is illustrated at the bottom of FIG. 23 and in FIG. 24. A straight line portion La is a region which has been exposed to light by a pixel column Sa in the pixel array. A straight line portion Lb is a region which has been exposed to light by a pixel column Sb in the pixel array. A straight line portion Le is a portion which has not been exposed to light by micromirrors, of which the number corresponds to a conceived deviation amount at a connecting portion. Specifically, the straight line portion Le is a non-exposed portion by the micromirrors which correspond to the space pixels Sa (16, e) through Sa (20, e). In other words, the straight line portion Le corresponds to a group J of space pixel image drawing spots, illustrated in FIGS. 22A, 22B and 22C.

Then, the exposure surface is exposed to light while the micromirrors corresponding to the conceivable deviation amount at the connecting portion are set to a non-exposure state. Further, a reference scale Ls, as illustrated in FIG. 25, is separately formed by the exposure head by exposing the exposure surface to light. The reference scale Ls is a straight line which is formed by performing exposure with micromirrors constituting one pixel column in the pixel array, and which extends in the direction of the X-axis. In the reference scale Ls, straight line portions L(n), L(n+1), L(n+2), L(n+3), L(n−1), L(n−2) and L(n−3), which are non-exposed portions, are formed. The straight line portions (n), L(n+1), L(n+2), L(n+3), L(n−1), L(n−2) and L(n−3) are formed by performing image drawing while n number of pixels (micromirrors), (n+1) number of pixels (micromirrors), (n+2) number of pixels (micromirrors), (n+3) number of pixels (micromirrors), (n−1) number of pixels (micromirrors), (n−2) number of pixels (micromirrors) and (n−3) number of pixels (micromirrors) are set to a non-exposure state and each of pixels (micromirrors) which are adjacent to the pixels in the non-exposure state is set to an exposure state.

The number (n) of pixel image drawing spots in each of the straight line portions L(n) in the reference scale Ls, is set to the same number as the number (n=5, in this case) of micromirrors, which corresponds to the conceivable deviation amount at a connecting portion. Therefore, the number of micromirrors corresponding to the deviation amount at a connecting portion can be obtained by comparing the length of each of the straight line portions Le and that of each of the straight line portions L(n−3) through L(n+3) in the reference scale Ls.

For example, if the length of the straight line portion Le is the same as that of the straight line portion L(n), the deviation amount at a connecting portion is nil (0). If the length of the straight portion Le is the same as that of the straight line portion L (n−3), the number of micromirrors corresponding to the deviation amount at a connecting portion is −3. Specifically, the pixel column Sa and the pixel column Sb overlap with each other by three micromirrors, in other words, by three pixels. Therefore, it is possible to suppress unevenness at a connecting portion between the pixel image drawing spot columns by designating pixels-to-utilize so that three micromirrors are not utilized at a connecting portion between the pixel column Sa and the pixel column Sb. The three micromirrors are not utilized by setting three micromirrors to a non-exposure state.

Further, for example, if the length of the straight line portion Le is the same as that of the straight line portion L (n+2), the number of micromirrors corresponding to the deviation amount at a connecting portion is +2. In this case, the pixel column Sa and the pixel column Sb are apart from each other by two micromirrors, and two pixels are missing. Therefore, two pixels are added to a connecting portion between the pixel column Sa and the pixel column Sb and exposure is performed by additionally designating two more micromirrors as pixels-to-utilize. Accordingly, it is possible to suppress unevenness at a connecting portion between the pixel image drawing spot columns.

As described above, an image of each of straight line portions La (Le), Lb and L (n) and an image of each of straight line portions L(n±1) . . . forming a reference scale are obtained. The image of each of the straight line portions is an image showing a portion in which image drawing corresponding to the connecting portion between the pixel columns is redundant or an image showing a portion in which image drawing is insufficient when predetermined N-tuple image drawing, as designed, is performed.

Then, a deviation amount at a connecting portion, in which image drawing is redundant or insufficient, is obtained based on information representing an image of each of the straight line portions. Then, pixels-to-utilize are selected from the usable pixels so that the redundant image drawing portion and the insufficient image drawing portion are compensated. The pixels-to-utilize are pixels in the pixel array which are utilized in actual exposure. Specifically, pixels-not-to-utilize are specified among the usable pixels and pixels other than the specified pixels-not-to-utilize are selected as the pixels-to-utilize so that unevenness is not generated at the connecting portion.

Then, setting is made, based on information representing the pixels-to-utilize (pixels-not-to-utilize), so that only the selected pixels-to-utilize actually operate among the usable pixels. Then, actual exposure is performed based on the setting.

Here, the length of the straight line portion Le and that of each of the straight line portions L(n), L(n±1) . . . may be visually compared with each other. Alternatively, a predetermined apparatus using a method which is different from the above method may be used to compare the lengths.

Further, in the exposure apparatus in the above embodiment and modified examples thereof, a DMD which modulates light emitted from a light source pixel by pixel is used as a pixel array. However, it is not necessary that the DMD is used as the pixel array. A light modulation element, such as a liquid crystal array, and a light source array (for example, LD (laser diode) array, LED (light emitting diode) array, organic EL (electroluminescent) array, or the like), other than the DMD, may be used as the pixel array.

Further, in the exposure apparatus in the above embodiment and modified examples thereof, exposure may be continuously performed while the exposure head is constantly moved. Alternatively, the exposure head may be moved stepwise and exposure may be performed by stopping the exposure head at each of the moved positions.

Further, the present invention may be applied to any kind of apparatus or method, other than the exposure apparatus and method, as far as the apparatus or method is an image drawing apparatus and an image drawing method in which a two-dimensional pattern represented by image data is formed on an image drawing surface by performing N-tuple image drawing (N is a natural number which is greater than or equal to 1) on the image drawing surface. For example, the present invention may be applied to an inkjet printer and an inkjet print method. Specifically, an inkjet recording head of an inkjet printer generally includes a nozzle which ejects ink droplets, and which is formed on a nozzle surface facing a recording medium (for example, recording paper, OHP (overhead projector) sheet or the like). Some inkjet printers can record images by performing N-tuple image drawing. In such inkjet printers, a plurality of nozzles is arranged to form a grid and the head, itself, is inclined with respect to the scan direction. In the inkjet printer which adopts the two-dimensional arrangement, as described above, an actual inclination angle of the head, itself, may be shifted from an ideal inclination angle. Further, in the ink jet printer, a pattern distortion may be present because of an arrangement error of the nozzle, itself, or the like. Even if the actual inclination angle is shifted from the ideal inclination angle, or even if a pattern distortion is present, it is possible to reduce unevenness in a drawn image by applying the present invention. The unevenness can be reduced by designating nozzles, of which the number is sufficient to minimize an influence of a mounting angle error of the head or a pattern distortion, as nozzles which will be actually utilized. Further, if multiple exposure, which is double exposure or like, is performed, unevenness caused by other factors can be eliminated by a compensation effect of the multiple exposure. Therefore, it is possible to further reduce unevenness in resolution or density in a recorded image.

Further, each of the embodiments has been described in detail as an example of the present invention. It is needless to say that the technical scope of the present invention should be defined only by the claims.

1-22. (canceled)

23. An image drawing apparatus for forming a two-dimensional pattern represented by image data on an image drawing surface by performing N-tuple image drawing (N is a natural number greater than or equal to 1), the apparatus comprising:
at least one image drawing head, each including a pixel array;
a movement unit for relatively moving each of the at least one image drawing head in a scan direction with respect to the image drawing surface; and
a pixel-to-utilize setting unit for setting pixels-to-utilize, based on variance in the inclination angles of pixel columns in the pixel array with respect to the scan direction, for each of the at least one image drawing heads, wherein each of the at least one image drawing head is mounted with respect to the image drawing surface so that the pixel column direction of usable pixels and a relative scan direction of each of the at least one image drawing head form a predetermined set inclination angle, and wherein the pixel array includes a great number of two-dimensionally arranged usable pixels and generates a group of image drawing spots which forms the two-dimensional pattern based on the image data, and wherein the pixel-to-utilize setting unit sets the pixels-to-utilize so that the pixels-to-utilize, which are utilized in the N-tuple image drawing, operate among the great number of usable pixels.

24. An image drawing apparatus, as defined in claim 23, wherein the pixel-to-utilize setting unit sets the pixels-to-utilize based on an actual inclination angle formed by an actual pixel column direction on the image drawing surface, represented by the group of image drawing spots, and the scan direction.

25. An image drawing apparatus, as defined in claim 23, wherein the pixel-to-utilize setting unit includes a pixel-to-utilize designation unit for designating the pixels-to-utilize and a setting changing unit for changing the setting so that only the pixels-to-utilize operate.

26. An image drawing apparatus, as defined in claim 25, wherein the set inclination angle θ satisfies the following arithmetic expression:
s·p·sin θ≧Nδ,
where s is the number of pixels constituting each of pixel columns of the usable pixels, p is a pixel pitch of the usable pixels in the pixel column direction, and δ is a pixel column pitch of the usable pixels along a direction perpendicular to the scan direction.

27. An image drawing apparatus, as defined in claim 25, wherein the pixel-to-utilize designation unit specifies an actual inclination angle formed by the actual direction of each of image drawing spot columns on the image drawing surface, represented by the group of image drawing spots, and the scan direction for each of the image drawing spot columns and designates the pixels-to-utilize so as to absorb an error between the actual inclination angle and the set inclination angle for each of the image drawing spot columns.

28. An image drawing apparatus, as defined in claim 25, wherein the pixel-to-utilize designation unit determines an image drawing spot column on the image drawing surface, which corresponds to each of a plurality of pixel columns selected from pixel columns of the usable pixels, as a representative image drawing spot column, specifies an actual inclination angle formed by the direction of the representative image drawing spot column and the scan direction for each of the representative image drawing spot columns and designates the pixels-to-utilize so that each error between the relevant actual inclination angle and the set inclination angle is absorbed.

29. An image drawing apparatus, as defined in claim 28, wherein the actual inclination angle of each of the representative image drawing spot columns is one of an average value, a median value, a maximum value and a minimum value of the actual inclination angle of the representative image drawing spot column and that of an image drawing spot column in the vicinity thereof.

30. An image drawing apparatus, as defined in claim 23, wherein the pixel array in each of the at least one image drawing head generates a group of light spots as the group of image drawing spots.

31. An image drawing apparatus, as defined in claim 25, wherein the pixel array in each of the at least one image drawing head generates a group of light spots as the group of image drawing spots, and wherein the pixel-to-utilize designation unit includes a position detection unit for detecting the positions of light spots constituting the group of light spots on the image drawing surface for each of the at least one image drawing head and a selection unit, wherein the selection unit selects, based on a detection result by the position detection unit, a plurality of representative regions, each including at least one image drawing portion formed by a connecting portion between pixel columns of the pixels-to-utilize on the image drawing surface, for each of the at least one image drawing head, specifies a pixel-not-to-utilize among the usable pixels so that ideal N-tuple image drawing is performed in each of the representative regions and selects pixels other than the pixel-not-to-utilize as the pixels-to-utilize.

32. An image drawing apparatus, as defined in claim 31, wherein the position detection unit detects the positions of at least two light spots in each of a plurality of pixel columns, and wherein the selection unit specifies, based on the result of detection, an actual inclination angle formed by the scan direction and the actual direction of each of the pixel columns represented by the light spots, and which have been projected onto the image drawing surface, and specifies the pixel-not-to-utilize based on the actual inclination angle.

33. An image drawing apparatus, as defined in claim 32, wherein the selection unit uses the column of the light spots on the image drawing surface, which corresponds to each of a plurality of pixel columns of usable pixels in the pixel array, as a representative light spot column and specifies the actual inclination angle of each of the plurality of representative light spot columns based on the result of detection of the positions of at least two light spots among light spots constituting the representative light spot column and a light spot column in the vicinity thereof by the position detection unit.

34. An image drawing apparatus, as defined in claim 33, wherein the selection unit uses a plurality of columns of the light spots on the image drawing surface, which corresponds to a plurality of pixel columns of the usable pixels, as representative light spot columns, specifies an individual actual inclination angle formed by the scan direction and the direction of each of the representative light spot columns and a light spot column in the vicinity thereof and regards a representative value of the individual actual inclination angles as the actual inclination angle of each of the representative light spot columns.

35. An image drawing apparatus, as defined in claim 34, wherein the representative value of the individual actual inclination angles is one of an average value, a median value, a maximum value and a minimum value of the individual actual inclination angles of the representative light spot column and a light spot column in the vicinity thereof.

36. An image drawing apparatus, as defined in claim 25, further comprising:
a reference image drawing unit for performing reference image drawing by using only pixels which constitute pixel columns having (N−1) column intervals therebetween from among the great number of usable pixels for each of the at least one image drawing head in order to designate the pixels-to-utilize by the pixel-to-utilize designation unit when N is greater than or equal to 2.

37. An image drawing apparatus, as defined in claim 25, further comprising:
a reference image drawing unit for performing reference image drawing by using only pixels, of which the number corresponds to 1/N of the total number of the usable pixels, and which constitute a group of pixel rows which are adjacent to each other, among the great number of usable pixels for each of the at least one image drawing head in order to designate the pixels-to-utilize by the pixel-to-utilize designation unit when N is greater than or equal to 2.

38. An image drawing apparatus, as defined in claim 23, further comprising:
a data conversion unit for converting the image data so that the size of a predetermined portion of the two-dimensional pattern represented by the image data becomes the same as that of a corresponding portion which can be drawn by use of the designated pixels-to-utilize.

39. An image drawing apparatus, as defined in claim 23, wherein the pixel array is a spatial light modulation element for modulating light emitted from a light source, based on the image data, for each pixel.

40. An image drawing apparatus, as defined in claim 23, wherein N is a natural number within the range from 3 to 7.

41. An image drawing method using at least one image drawing head which includes a pixel array, wherein each of the at least one image drawing head is mounted with respect to the image drawing surface so that the pixel column direction of usable pixels and a relative scan direction of each of the at least one image drawing head form a predetermined set inclination angle, and wherein the pixel array includes a great number of two-dimensionally arranged usable pixels and generates, based on image data, a group of image drawing spots which forms a two-dimensional pattern represented by the image data, the method comprising the steps of:
setting pixels-to-utilize, based on variance in the inclination angles of pixel columns in the pixel array with respect to the scan direction, so that the pixels-to-utilize, which are utilized in N-tuple image drawing (N is a natural number greater than or equal to 1), operate among the great number of usable pixels for each of the at least one image drawing head; and
forming the two-dimensional pattern on the image drawing surface by causing each of the at least one image drawing head to operate while relatively moving each of the at least one image drawing head in the scan direction with respect to the image drawing surface.

42. An image drawing method, as defined in claim 41, wherein the step of setting the pixels-to-utilize is performed based on an actual inclination angle formed by an actual pixel column direction on the image drawing surface, represented by the group of image drawing spots, and the scan direction.

43. An image drawing method, as defined in claim 41, wherein the step of setting the pixels-to-utilize includes a step of designating the pixels-to-utilize and a step of changing the setting so that only the pixels-to-utilize operate.

44. An image drawing method, comprising the steps of:
relatively moving at least one head with respect to an image drawing surface in a scanning direction; and
forming beam spots on the image drawing surface by the at least one head, the beam spots being arranged two-dimensionally such that column directions of the beam spots and the scan direction are different, each of the beam spots on each column being selected based on the difference between the scanning direction and each of the column directions such that the image drawing surface is scanned N times (N is a natural number greater than or equal to 1) by the beam spots on each of the columns.
